(19) United States
(12) Patent Application Publication
(10) Pub. No.: US 2026/0128227 A1
(43) Pub. Date: May 7, 2026

(54) THREE-TERMINAL MULTILAYER CERAMIC CAPACITOR

(71) Applicant: Murata Manufacturing Co., Ltd., Nagaokakyo-shi (JP)

(72) Inventor: Kentarou FUJIWARA, Nagaokakyo-shi (JP)

(21) Appl. No.: 19/439,816

(22) Filed: Jan. 5, 2026

Related U.S. Application Data
(63) Continuation of application No. PCT/JP2024/016302, filed on Apr. 25, 2024.

(30) Foreign Application Priority Data
Jul. 10, 2023 (JP) 2023-112815

(51) Int. Cl. H01G 4/30; H01G 4/012; H01G 4/232

(52) U.S. Cl. CPC H01G 4/30; H01G 4/012; H01G 4/2325

(57) ABSTRACT

A three-terminal multilayer ceramic capacitor includes third and fourth base electrode layers including a joining portion, which is joined to first and second side surfaces, and first and second separated portions, which are spaced farther from the first and second side surfaces toward first and second end surfaces than the joining portion, and third and fourth plating layers including first and second edge portions extending along the first and second separated portions between the first and second separated portions and the first and second side surfaces, and a surface layer portion covering outer surfaces of the third and fourth base electrode layers continuously with the first and second edge portions.

### CROSS REFERENCE TO RELATED APPLICATIONS

This application claims the benefit of priority to Japanese Patent Application No. 2023-112815 filed on Jul. 10, 2023 and is a Continuation Application of PCT Application No. PCT/JP2024/016302 filed on Apr. 25, 2024. The entire contents of each application are hereby incorporated herein by reference.

### BACKGROUND OF THE INVENTION

### 1. Field of the Invention

The present invention relates to three-terminal multilayer ceramic capacitors.

### 2. Description of the Related Art

Japanese Unexamined Patent Application Publication No. 2010-109238 discloses a two-terminal multilayer ceramic capacitor including a pair of external electrodes. The two-terminal multilayer ceramic capacitor includes a multilayer body including a pair of main surfaces, a pair of lateral surfaces, and a pair of end surfaces, and a pair of external electrodes each provided on a corresponding one of the pair of end surfaces, a portion of each of the pair of main surfaces, and a portion of each of the pair of lateral surfaces of the multilayer body. Each of the pair of external electrodes includes a proximal-end-side bonding portion bonded to one of the main surfaces and a distal-end-side separation portion separated from the main surface at a distal end of the proximal-end-side bonding portion. Since the external electrode is separated from the multilayer body at the distal-end-side separation portion, it is possible to suppress the strong bonding between the external electrode and the multilayer body. Therefore, it is possible to reduce or prevent cracks in the two-terminal multilayer ceramic capacitor.

In addition, a multilayer feedthrough ceramic capacitor having a general configuration, that is, a three-terminal multilayer ceramic capacitor, is also known. The three-terminal multilayer ceramic capacitor includes a multilayer body including a pair of main surfaces, a pair of lateral surfaces, and a pair of end surfaces, and external electrodes provided on outer surfaces of the multilayer body. The external electrodes include a pair of end surface electrodes provided on the pair of end surfaces, a portion of each of the pair of main surfaces, and a portion of each of the pair of lateral surfaces of the multilayer body, and a pair of lateral surface electrodes each provided on a corresponding one of the pair of lateral surfaces and each on a portion of each of the pair of main surfaces of the multilayer body. In each of the lateral surface electrodes, an end portion (an e-dimension end portion) of the lateral surface electrode is provided so as to be in contact with the multilayer body. Specifically, each of the lateral surface electrodes includes a base electrode layer including an e-dimension end portion in contact with the multilayer body, and a plated layer, which functions as an upper layer that covers the base electrode layer. By applying solder to the surface of the plated layer, the three-terminal multilayer ceramic capacitor can be mounted on a board.

However, although Japanese Unexamined Patent Application Publication No. 2010-109238 discloses a configuration for suppressing the occurrence of cracks in the end surface electrode, Japanese Unexamined Patent Application Publication No. 2010-109238 discloses only a two-terminal multilayer ceramic capacitor, and therefore, Japanese Unexamined Patent Application Publication No. 2010-109238 does not disclose any configuration for suppressing the occurrence of cracks in the lateral surface electrode. In addition, in a general three-terminal multilayer ceramic capacitor, as described above, the e-dimension end portion of the lateral surface electrode is in contact with the multilayer body, and the lateral surface electrode and the multilayer body are firmly bonded to each other, and therefore, when the three-terminal multilayer ceramic capacitor is bent due to an external factor or the like, for example, cracks occur in the multilayer body from the e-dimension end portion of the lateral surface electrode. Therefore, the reliability of the three-terminal multilayer ceramic capacitor is lowered.

In addition, in the lateral surface electrode of the three-terminal multilayer ceramic capacitor, the base electrode layer is formed with the e-dimension end portion in contact with the multilayer body, the plated layer is formed so as to cover the base electrode layer, and the surface area of the plated layer is determined according to the width of the plated layer. In other words, as the width of the plated layer is smaller, the surface area of the plated layer becomes smaller, and the bonding area between the solder and the plated layer also becomes smaller. Therefore, the bonding property between the three-terminal multilayer ceramic capacitor and the board is reduced, and the mountability is reduced.

### SUMMARY OF THE INVENTION

Example embodiments of the present invention provide three-terminal multilayer ceramic capacitors each with an improved bonding property and improved mountability to a board, while reducing or preventing cracks.

A three-terminal multilayer ceramic capacitor according to an example embodiment of the present invention includes a multilayer body including a plurality of ceramic layers and a plurality of internal electrode layers that are laminated, a first main surface and a second main surface opposed to each other in a height direction, a first end surface and a second end surface opposed to each other in a length direction orthogonal or substantially orthogonal to the height direction, and a first lateral surface and a second lateral surface opposed to each other in a width direction orthogonal or substantially orthogonal to the height direction and the length direction, and a plurality of external electrodes. The plurality of internal electrode layers include a plurality of first internal electrode layers each extending toward the first end surface and the second end surface, and a plurality of second internal electrode layers each extending toward the first lateral surface and the second lateral surface. The plurality of external electrodes include a first external electrode including a first base electrode layer and a first plated layer on the first base electrode layer, the first external electrode being provided on the first end surface and connected to the plurality of first internal electrode layers, a second external electrode including a second base electrode layer and a second plated layer on the second base electrode layer, the second external electrode being provided on the second end surface and connected to the plurality of first internal electrode layers, a third external electrode including a third base electrode layer and a third plated layer on the third base electrode layer, the third external electrode being provided on the first lateral surface and connected to the plurality of second internal electrode layers, and a fourth external electrode including a fourth base electrode layer and a fourth plated layer on the fourth base electrode layer, the fourth external electrode being provided on the second lateral surface and connected to the plurality of second internal electrode layers. The plurality of first internal electrode layers each include a first counter electrode portion opposed to a corresponding one of the plurality of second internal electrode layers, a first extension electrode portion extending from the first counter electrode portion toward the first end surface, and a second extension electrode portion extending from the first counter electrode portion toward the second end surface. The plurality of second internal electrode layers each include a second counter electrode portion opposed to a corresponding one of the plurality of first counter electrode portions, a third extension electrode portion extending from the second counter electrode portion toward the first lateral surface, and a fourth extension electrode portion extending from the second counter electrode portion toward the second lateral surface. In a cross-sectional view along the first main surface and the second main surface, each of the third base electrode layer and the fourth base electrode layer includes a bonding portion including a middle portion located at a middle in the length direction and bonded to a corresponding one of the first lateral surface and the second lateral surface, a first separation portion located closer to the first end surface than the bonding portion is and separated from a corresponding one of the first lateral surface and the second lateral surface, and a second separation portion located closer to the second end surface than the bonding portion is and separated from a corresponding one of the first lateral surface and the second lateral surface. In the cross-sectional view along the first main surface and the second main surface, each of the third plated layer and the fourth plated layer includes a first edge portion extending along the first separation portion between the first separation portion and a corresponding one of the first lateral surface and the second lateral surface, a second edge portion extending along the second separation portion between the second separation portion and a corresponding one of the first lateral surface and the second lateral surface, and a surface layer portion covering an outer surface of a corresponding one of the third base electrode layer and the fourth base electrode layer continuously from the first edge portion and the second edge portion.

According to the above configuration, it is possible to reduce or prevent the occurrence of cracks due to the stress relaxation by the third and fourth base electrode layers, and it is possible to further ensure the surface areas of the third and fourth plated layers by the first and second edge portions, thus improving the bonding property with the board and the mountability.

According to example embodiments of the present invention, three-terminal multilayer ceramic capacitors each with an improved bonding property and improved mountability to a board, while reducing or preventing cracks are provided.

The above and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an external perspective view showing an example of a three-terminal multilayer ceramic capacitor according to an example embodiment of the present invention.

FIG. 2 is a top view showing an example of a three-terminal multilayer ceramic capacitor according to an example embodiment of the present invention.

FIG. 3 is a front view showing an example of a three-terminal multilayer ceramic capacitor according to an example embodiment of the present invention.

FIG. 4 is a cross-sectional view taken along the line IV-IV of FIG. 1.

FIG. 5 is a cross-sectional view taken along the line V-V of FIG. 1.

FIG. 6 is a cross-sectional view taken along the line VI-VI of FIG. 4.

FIG. 7 is a cross-sectional view taken along the line VII-VII of FIG. 4.

FIG. 8A is an enlarged photograph of a base electrode layer in a portion a of FIG. 7, and FIG. 8B is an enlarged photograph of a base electrode layer and a plated layer in a portion a of FIG. 7.

FIG. 9 is an enlarged schematic view of a portion a of FIG. 7, showing a state of a third base electrode layer and a third plated layer and the dimensions of each portion.

FIG. 10A is a schematic cross-sectional view showing a configuration of a third base electrode layer and a third plated layer in an existing three-terminal multilayer ceramic capacitor, and FIG. 10B a schematic cross-sectional view showing a configuration of a third base electrode layer and a third plated layer in a three-terminal multilayer ceramic capacitor according to an example embodiment of the present invention.

### DETAILED DESCRIPTION OF THE EXAMPLE EMBODIMENTS

Example embodiments of the present invention will be described in detail with reference to the drawings.

A three-terminal multilayer ceramic capacitor according to an example embodiment of the present invention will be described.

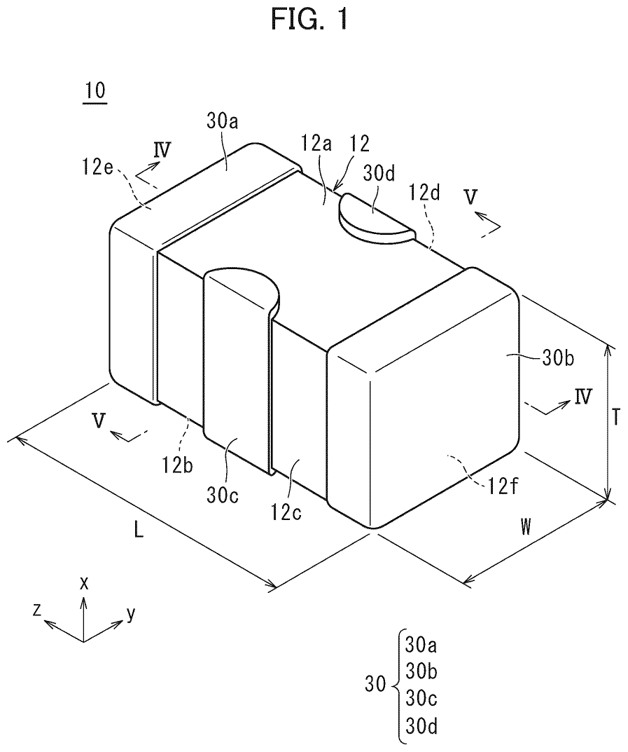

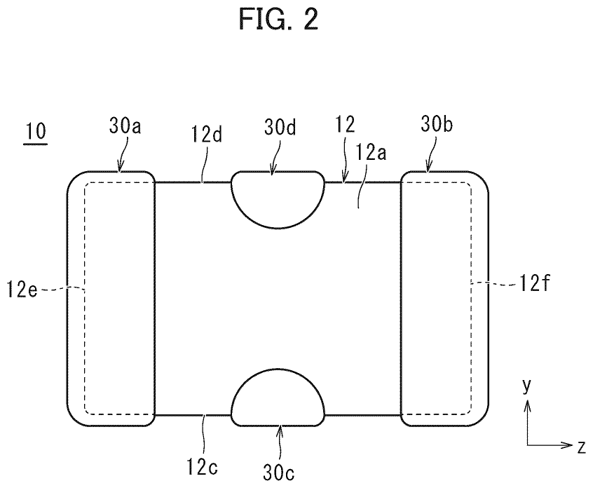

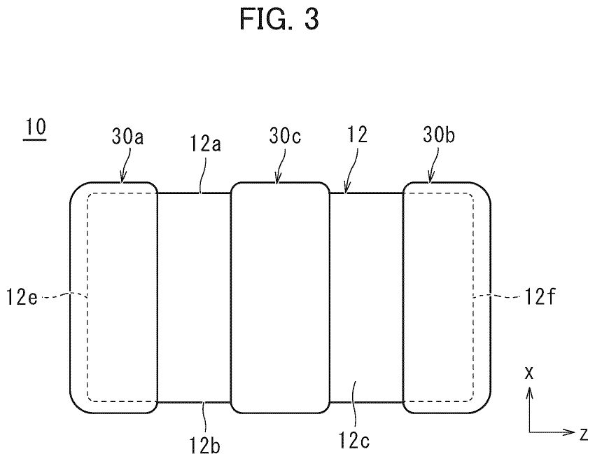

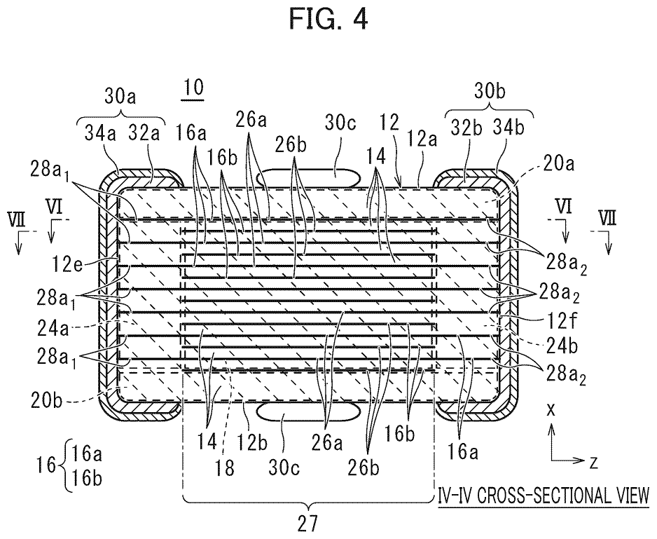

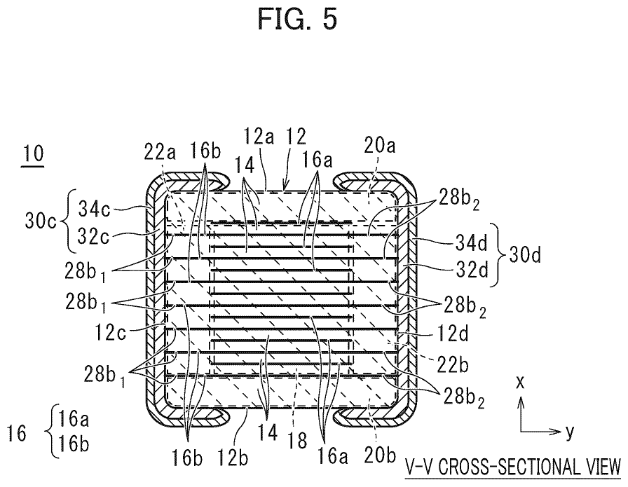

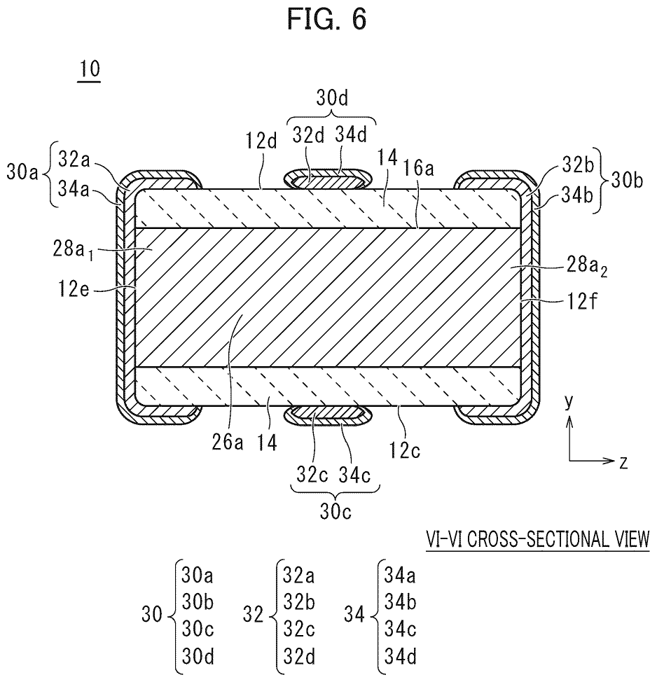

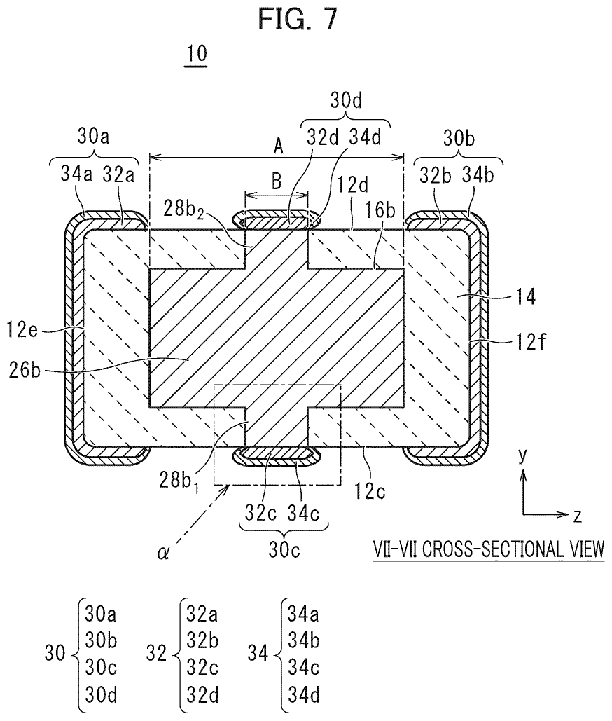

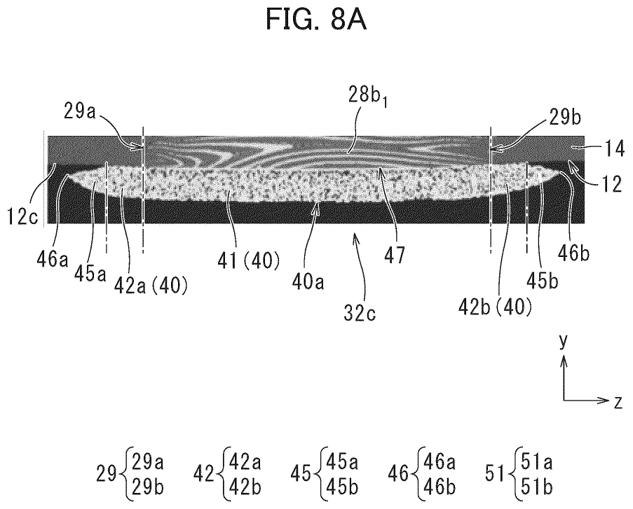

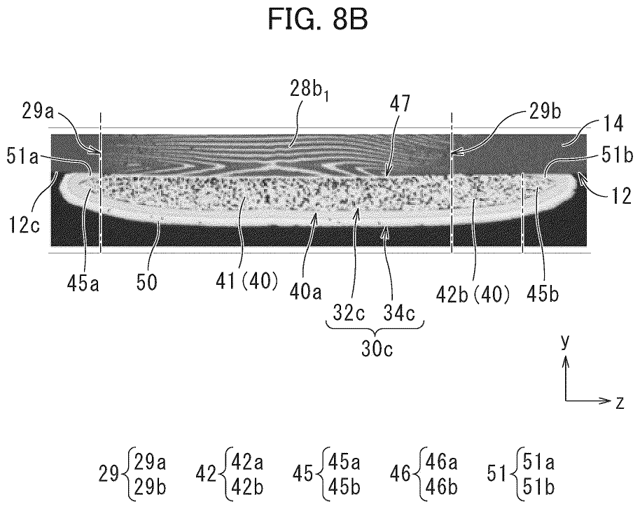

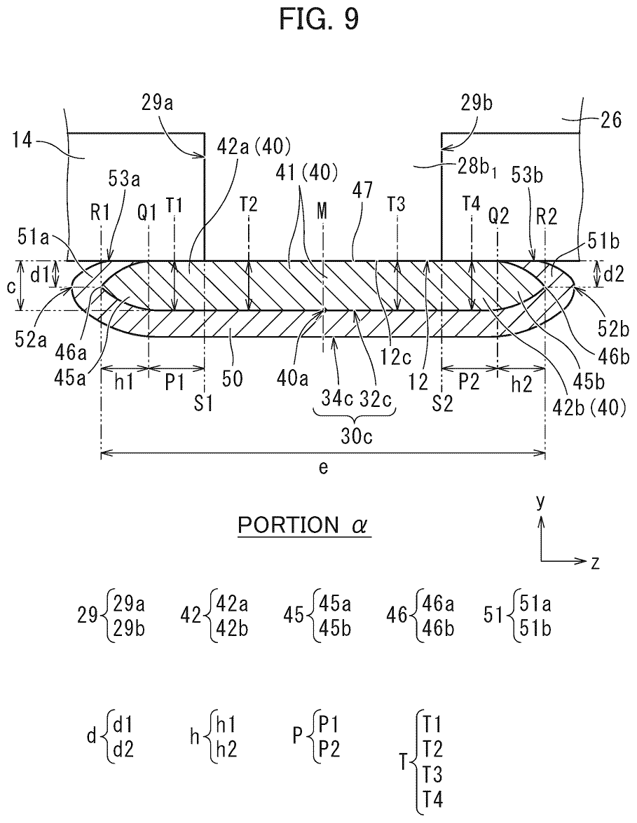

FIG. 1 is an external perspective view showing an example of a three-terminal multilayer ceramic capacitor according to an example embodiment of the present invention. FIG. 2 is a top view showing an example of a three-terminal multilayer ceramic capacitor according to an example embodiment of the present invention. FIG. 3 is a front view showing an example of a three-terminal multilayer ceramic capacitor according to an example embodiment of the present invention. FIG. 4 is a cross-sectional view taken along the line IV-IV of FIG. 1. FIG. 5 is a cross-sectional view taken along the line V-V of FIG. 1. FIG. 6 is a cross-sectional view taken along the line VI-VI of FIG. 4. FIG. 7 is a cross-sectional view taken along the line VII-VII of FIG. 4. FIG. 8A is an enlarged photograph of a base electrode layer in a portion a of FIG. 7, and FIG. 8B is an enlarged photograph of a base electrode layer and a plated layer in a portion a of FIG. 7. FIG. 9 is an enlarged schematic view of a portion a of FIG. 7, showing a state of a third base electrode layer and a third plated layer and the dimensions of each portion.

As shown in FIG. 1, a three-terminal multilayer ceramic capacitor 10 includes, for example, a rectangular or substantially rectangular parallelepiped multilayer body 12 and external electrodes 30.

The multilayer body 12 includes a plurality of laminated ceramic layers 14 and a plurality of laminated internal electrode layers 16 each on a corresponding one of the plurality of ceramic layers 14. The ceramic layers 14 and the internal electrode layers 16 are laminated in the height direction x.

The multilayer body 12 includes a first main surface 12a and a second main surface 12b opposed to each other in the height direction x, a first lateral surface 12c and a second lateral surface 12d opposed to each other in the width direction y orthogonal or substantially orthogonal to the height direction x, and a first end surface 12e and a second end surface 12f opposed to each other in the length direction z orthogonal or substantially orthogonal to the height direction x and the width direction y. The multilayer body 12 includes rounded corner portions and rounded ridge portions. In addition, the corner portion refers to a portion where three adjacent surfaces of the multilayer body intersect, and the ridge portion refers to a portion where two adjacent surfaces of the multilayer body intersect. In addition, unevenness and the like may be provided on a portion or all of the first main surface 12a and the second main surface 12b, the first lateral surface 12c and the second lateral surface 12d, and the first end surface 12e and the second end surface 12f. In addition, the dimension L of the multilayer body 12 in the length direction z is not necessarily longer than the dimension W in the width direction y.

The multilayer body 12 includes an inner layer portion 18, and a first main surface-side outer layer portion 20a and a second main surface-side outer layer portion 20b that sandwich the inner layer portion 18 in the lamination direction.

The inner layer portion 18 includes a plurality of ceramic layers 14 and a plurality of internal electrode layers 16. The inner layer portion 18 includes an internal electrode layer 16 located closest to the first main surface 12a to an internal electrode layer 16 located closest to the second main surface 12b in the lamination direction. The internal electrode layers 16 include first internal electrode layers 16a each extending toward the first end surface 12e and the second end surface 12f, and second internal electrode layers 16b each extending toward the first lateral surface 12c and the second lateral surface 12d. In the inner layer portion 18, a plurality of the first internal electrode layers 16a and a plurality of the second internal electrode layers 16b are opposed to each other with a corresponding one of the ceramic layers 14 interposed therebetween. The inner layer portion 18 is a portion that generates capacitance and substantially defines and functions as a capacitor.

The first main surface-side outer layer portion 20a is located adjacent to the first main surface 12a, and includes a plurality of ceramic layers 14 located between the first main surface 12a, and the outermost surface of the inner layer portion 18 adjacent to the first main surface 12a and one straight line of the outermost surface (an extension line from the outermost surface to the first lateral surface 12c, the second lateral surface 12d, the first end surface 12e, and the second end surface 12f). That is, the first main surface-side outer layer portion 20a is an aggregate of the plurality of ceramic layers 14 located between the first main surface 12a and the internal electrode layer 16 closest to the first main surface 12a. The ceramic layers 14 used in the first main surface-side outer layer portion 20a may be the same as the ceramic layers 14 used in the inner layer portion 18. Similarly, the second main surface-side outer layer portion 20b includes a plurality of ceramic layers 14 located adjacent to the second main surface 12b and located between the second main surface 12b, and the outermost surface of the inner layer portion 18 adjacent to the second main surface 12b and one straight line of the outermost surface (an extension line from the outermost surface to the first lateral surface 12c, the second lateral surface 12d, the first end surface 12e, and the second end surface 12f). That is, the second main surface-side outer layer portion 20b is an aggregate of the plurality of ceramic layers 14 located between the second main surface 12b and the internal electrode layer 16 closest to the second main surface 12b. The ceramic layers 14 used in the second main surface-side outer layer portion 20b may be the same as the ceramic layers 14 used in the inner layer portion 18.

In addition, the multilayer body 12 includes a first lateral surface-side outer layer portion 22a which is located adjacent to the first lateral surface 12c and includes a plurality of ceramic layers 14 located between the first lateral surface 12c and the outermost surface of the inner layer portion 18 adjacent to the first lateral surface 12c. Similarly, the multilayer body 12 includes a second lateral surface-side outer layer portion 22b which is located adjacent to the second lateral surface 12d and including a plurality of ceramic layers 14 located between the second lateral surface 12d and the outermost surface of the inner layer portion 18 adjacent to the second lateral surface 12d. In addition, the first lateral surface-side outer layer portion 22a and the second lateral surface-side outer layer portion 22b are also referred to as W gaps or side gaps.

Further, the multilayer body 12 includes a first end surface-side outer layer portion 24a which is located adjacent to the first end surface 12e and includes a plurality of ceramic layers 14 located between the first end surface 12e and the outermost surface of the inner layer portion 18 adjacent to the first end surface 12e. Similarly, the multilayer body 12 includes a second end surface-side outer layer portion 24b which is located adjacent to the second end surface 12f and includes a plurality of ceramic layers 14 located between the second end surface 12f and the outermost surface of the inner layer portion 18 adjacent to the second end surface 12f. In addition, the first end surface-side outer layer portion 24a and the second end surface-side outer layer portion 24b are also referred to as L gaps or end gaps.

The dimensions of the multilayer body 12 are not particularly limited.

The ceramic layers 14 can be made of, for example, a dielectric material as a ceramic material. As such a dielectric material, for example, dielectric ceramic including a component such as BaTiO₃, CaTiO₃, SrTiO₃, or CaZrO₃ can be used. In a case where the dielectric material is included as a main component, a subcomponent having a lower content than the main component, such as, for example, a Mn compound, a Fe compound, a Cr compound, a Co compound, or a Ni compound, may be added according to the desired characteristics of the multilayer body 12.

The thickness of each ceramic layer 14 after firing is preferably, for example, about 0.3 μm or more and about 5.0 μm or less. The number of laminated ceramic layers 14 is preferably, for example, 75 or more and 1500 or less. In addition, the number of the ceramic layers 14 is the total number of the number of the ceramic layers 14 of the inner layer portion 18 and the number of the ceramic layers 14 of the first main surface-side outer layer portion 20a and the second main surface-side outer layer portion 20b.

The multilayer body 12 includes a plurality of the first internal electrode layers 16a and a plurality of the second internal electrode layers 16b as the plurality of internal electrode layers 16. The plurality of first internal electrode layers 16a are provided on the plurality of ceramic layers 14 and extend toward the first end surface 12e and the second end surface 12f. The plurality of second internal electrode layers 16b are provided on the plurality of ceramic layers 14 and extend toward the first lateral surface 12c and the second lateral surface 12d. The plurality of first internal electrode layers 16a and the plurality of second internal electrode layers 16b may be alternately laminated via a corresponding one of the ceramic layers 14, or after a plurality of ceramic layers 14 in which the first internal electrode layers 16a are provided are laminated, the ceramic layers 14 in which the second internal electrode layers 16b are provided may be laminated. In this way, it is possible to change the lamination pattern according to the desired capacitance value.

As shown in FIG. 6, each of the first internal electrode layers 16a includes a first counter electrode portion 26a opposed to the second internal electrode layers 16b, a first extension electrode portion 28a₁ extending from the first counter electrode portion 26a toward the surface of the first end surface 12e of the multilayer body 12, and a second extension electrode portion 28a₂ extending from the first counter electrode portion 26a toward the surface of the second end surface 12f of the multilayer body 12. Specifically, the first extension electrode portion 28a₁ is exposed on the surface of the first end surface 12e of the multilayer body 12, and the second extension electrode portion 28a₂ is exposed on the surface of the second end surface 12f of the multilayer body 12. Therefore, each of the first internal electrode layers 16a is not exposed on the surfaces of the first lateral surface 12c or the second lateral surface 12d of the multilayer body 12. The first extension electrode portion 28a₁ is connected to the first external electrode 30a, and the second extension electrode portion 28a₂ is connected to the second external electrode 30b.

The shape of the first counter electrode portion 26a and the shapes of the first extension electrode portion 28a₁ and the second extension electrode portion 28a₂ are not particularly limited, but are preferably rectangular or substantially rectangular. However, the corner portions may be rounded.

In addition, the lengths of the first extension electrode portion 28a₁ and the second extension electrode portion 28a₂ in the width direction y may be equal to or shorter than the length of the first counter electrode portion 26a in the width direction y. In addition, the shapes of the first extension electrode portion 28a₁ and the second extension electrode portion 28a₂ may be tapered shapes.

As shown in FIG. 7, each of the second internal electrode layers 16b has a substantially cross shape, and includes a second counter electrode portion 26b opposed to the first counter electrode portion 26a, a third extension electrode portion 28b₁ extending from the second counter electrode portion 26b toward the surface of the first lateral surface 12c of the multilayer body 12, and a fourth extension electrode portion 28b₂ extending from the second counter electrode portion 26b toward the surface of the second lateral surface 12d of the multilayer body 12. Specifically, the third extension electrode portion 28b₁ is exposed on the surface of the first lateral surface 12c of the multilayer body 12, and the fourth extension electrode portion 28b₂ is exposed on the surface of the second lateral surface 12d of the multilayer body 12. Therefore, the second internal electrode layer 16b is not exposed on the surface of the first end surface 12e or the surface of the second end surface 12f of the multilayer body 12. The third extension electrode portion 28b₁ is connected to the third external electrode 30c, and the fourth extension electrode portion 28b₂ is connected to the fourth external electrode 30d.

The shape of the second counter electrode portion 26b and the shapes of the third extension electrode portion 28b₁ and the fourth extension electrode portion 28b₂ are preferably rectangular or substantially rectangular. However, the corner portions may be rounded.

The relationship between the dimension A in the length direction z between the side of the second counter electrode portion 26b adjacent to the first end surface 12e and the side adjacent to the second end surface 12f and the dimension B in the length direction z between the side adjacent to the first end surface 12e and the side adjacent to the second end surface 12f of the third extension electrode portion 28b₁ and the fourth extension electrode portion 28b₂ is preferably A≥B.

The shape of the third extension electrode portion 28b₁ may be a tapered shape having a narrower width as it approaches the first lateral surface 12c, and the shape of the fourth extension electrode portion 28b₂ may be a tapered shape having a narrower width as it approaches the second lateral surface 12d.

In addition, the multilayer body 12 includes a counter electrode portion region 27. The counter electrode portion region 27 refers to a portion where the first counter electrode portion 26a of the first internal electrode layer 16a and the second counter electrode portion 26b of the second internal electrode layer 16b are opposed to each other. The counter electrode portion region 27 is configured as a portion of the inner layer portion 18. In addition, the counter electrode portion region 27 is also referred to as a capacitor effective portion.

It is possible to configure the first internal electrode layers 16a and the second internal electrode layers 16b of, for example, a suitable electrically conductive material such as a metal including Ni as a main component, such as Cu, Ag, Pd, or Au, or an alloy including at least one of these metals, such as an Ag—Pd alloy.

The number of the first internal electrode layers 16a and the second internal electrode layers 16b is not particularly limited, but is preferably, for example, 10 or more and 2000 or less in total.

The thickness of each first internal electrode layer 16a is not particularly limited, but is preferably, for example, about 0.30 μm or more and about 1.0 μm or less. The thickness of each second internal electrode layer 16b is not particularly limited, but is preferably, for example, about 0.30 μm or more and about 1.0 μm or less.

The external electrodes 30 are provided on the first end surface 12e and the second end surface 12f, the first lateral surface 12c and the second lateral surface 12d, and the first main surface 12a and the second main surface 12b of the multilayer body 12.

The external electrodes 30 include a first external electrode 30a, a second external electrode 30b, a third external electrode 30c, and a fourth external electrode 30d.

The first external electrode 30a is connected to the first internal electrode layers 16a and is provided on the surface of the first end surface 12e. In addition, in the present example embodiment, the first external electrode 30a extends from the first end surface 12e of the multilayer body 12 and is also provided on a portion of the first main surface 12a and a portion of the second main surface 12b, and a portion of the first lateral surface 12c and a portion of the second lateral surface 12d. In this case, the first external electrode 30a is electrically connected to the first extension electrode portions 28a₁ of the first internal electrode layers 16a. In addition, the first external electrode 30a may be provided only on the surface of the first end surface 12e. The first external electrode 30a of the present example embodiment includes a first base electrode layer 32a and a first plated layer 34a. The first base electrode layer 32a is in contact with and bonded to the multilayer body 12 on respective surfaces opposed to the first end surface 12e, the first main surface 12a, the second main surface 12b, the first lateral surface 12c, and the second lateral surface 12d. The first plated layer 34a covers the first base electrode layer 32a.

The second external electrode 30b is connected to the first internal electrode layers 16a and is provided on the surface of the second end surface 12f. In addition, in the present example embodiment, the second external electrode 30b extends from the second end surface 12f of the multilayer body 12 and is also provided on a portion of the first main surface 12a and a portion of the second main surface 12b, and a portion of the first lateral surface 12c and a portion of the second lateral surface 12d. In this case, the second external electrode 30b is electrically connected to the second extension electrode portions 28a₂ of the first internal electrode layers 16a. In addition, the second external electrode 30b may be provided only on the surface of the second end surface 12f. The second external electrode 30b of the present example embodiment includes a second base electrode layer 32b and a second plated layer 34b. The second base electrode layer 32b is in contact with and bonded to the multilayer body 12 on respective surfaces opposed to the second end surface 12f, the first main surface 12a, the second main surface 12b, the first lateral surface 12c, and the second lateral surface 12d. The second plated layer 34b covers the second base electrode layer 32b.

The third external electrode 30c is connected to the second internal electrode layers 16b and is provided on the surface of the first lateral surface 12c. In addition, in the present example embodiment, the third external electrode 30c extends from the first lateral surface 12c of the multilayer body 12 and is also provided on a portion of the first main surface 12a and a portion of the second main surface 12b. In this case, the third external electrode 30c is electrically connected to the third extension electrode portions 28b₁ of the second internal electrode layers 16b. In addition, the third external electrode 30c may be provided only on the surface of the first lateral surface 12c. The third external electrode 30c of the present example embodiment includes a third base electrode layer 32c and a third plated layer 34c. The third base electrode layer 32c is not in contact with the entirety of the surface opposed to the first lateral surface 12c, and includes separation portions 45 separated from the first lateral surface 12c. The third plated layer 34c covers the third base electrode layer 32c.

The fourth external electrode 30d is connected to the second internal electrode layers 16b and is provided on the surface of the second lateral surface 12d. In addition, in the present example embodiment, the fourth external electrode 30d extends from the second lateral surface 12d of the multilayer body 12 and is also provided on a portion of the first main surface 12a and a portion of the second main surface 12b. In this case, the fourth external electrode 30d is electrically connected to the fourth extension electrode portions 28b₂ of the second internal electrode layers 16b. In addition, the fourth external electrode 30d may be provided only on the surface of the second lateral surface 12d. The fourth external electrode 30d of the present example embodiment includes a fourth base electrode layer 32d and a fourth plated layer 34d. The fourth base electrode layer 32d is not in contact with the entirety of the surface opposed to the second lateral surface 12d, and includes separation portions 45 separated from the second lateral surface 12d. The fourth plated layer 34d covers the fourth base electrode layer 32d.

In the multilayer body 12, the first counter electrode portion 26a of the first internal electrode layers 16a and the second counter electrode portion 26b of the second internal electrode layers 16b are opposed to each other with the ceramic layers 14 interposed therebetween, such that capacitance is generated. Therefore, it is possible to obtain capacitance between the first external electrode 30a and the second external electrode 30b to which the first internal electrode layers 16a are connected and the third external electrode 30c and the fourth external electrode 30d to which the second internal electrode layers 16b are connected, such that characteristics of the capacitor are provided.

The external electrodes 30 each include a base electrode layer 32 including a metal component and a glass component, and a plated layer 34 provided on a surface of the base electrode layer 32.

The base electrode layer 32 includes a first base electrode layer 32a, a second base electrode layer 32b, a third base electrode layer 32c, and a fourth base electrode layer 32d.

The first base electrode layer 32a is connected to the first internal electrode layers 16a and is provided on the surface of the first end surface 12e. In addition, the first base electrode layer 32a extends from the first end surface 12e and is also provided on a portion of the first main surface 12a and a portion of the second main surface 12b, and a portion of the first lateral surface 12c and a portion of the second lateral surface 12d. In addition, the first base electrode layer 32a may be provided only on the surface of the first end surface 12e. The second base electrode layer 32b is connected to the first internal electrode layers 16a and is provided on the surface of the second end surface 12f. In addition, the second base electrode layer 32b extends from the second end surface 12f and is also provided on a portion of the first main surface 12a and a portion of the second main surface 12b, and a portion of the first lateral surface 12c and a portion of the second lateral surface 12d. In addition, the second base electrode layer 32b may be provided only on the surface of the second end surface 12f.

The third base electrode layer 32c is connected to the second internal electrode layers 16b and is provided on the surface of the first lateral surface 12c. In addition, the third base electrode layer 32c extends from the first lateral surface 12c and is also provided on a portion of the first main surface 12a and a portion of the second main surface 12b. In addition, the third base electrode layer 32c may be provided only on the surface of the first lateral surface 12c. The fourth base electrode layer 32d is connected to the second internal electrode layers 16b and is provided on the surface of the second lateral surface 12d. In addition, the fourth base electrode layer 32d extends from the second lateral surface 12d and is also provided on a portion of the first main surface 12a and a portion of the second main surface 12b. In addition, the fourth base electrode layer 32d may be provided only on the surface of the second lateral surface 12d.

As shown in FIGS. 8A, 8B, and 9, each of the third and fourth base electrode layers 32c and 32d in the present example embodiment includes the separation portions 45 including a first separation portion 45a and a second separation portion 45b. The characteristic shapes of the third and fourth base electrode layers 32c and 32d of the present example embodiment will be described later in detail.

The base electrode layer 32 includes at least one of, for example, a fired layer, an electrically conductive resin layer, and the like. In addition, in the Experimental Examples described later, the base electrode layer 32 is a fired layer. Hereinafter, each configuration in the case where the base electrode layer 32 is the fired layer or electrically conductive resin layer will be described.

The fired layer includes a glass component and a metal component. The glass component of the fired layer includes at least one of, for example, B, Si, Ba, Mg, Al, Li, or the like. As the metal component of the fired layer, for example, Cu is a main component, and at least one of Ni, Ag, Pd, an Ag—Pd alloy, Au, or the like is included. The fired layer is formed by applying an electrically conductive paste including a glass component and a metal component to the multilayer body 12 and firing the paste. The fired layer may be formed by simultaneously firing the multilayer chip having the internal electrode layers 16 and the ceramic layers 14 and the electrically conductive paste applied to the multilayer chip, or may be formed by firing the multilayer chip having the internal electrode layers 16 and the ceramic layers 14 to obtain the multilayer body 12, and then firing the electrically conductive paste to the multilayer body 12. In addition, when the multilayer chip including the internal electrode layers 16 and the ceramic layers 14 and the electrically conductive paste applied to the multilayer chip are fired at the same time, it is preferable that the fired layer is formed by firing a material to which a dielectric material is added instead of a glass component. The fired layer may include a plurality of layers.

In addition, when the base electrode layer 32 includes a dielectric material instead of a glass component, it is possible to improve the adhesion (bonding property) between the multilayer body 12 and the base electrode layer 32. In addition, the base electrode layer 32 may include both a glass component and a dielectric component.

As the dielectric material included in the base electrode layer 32, the same type of dielectric material as the ceramic layers 14 may be used, or a different type of dielectric material may be used. The dielectric component includes, for example, at least one of BaTiO₃, CaTiO₃, (Ba, Ca) TiO₃, SrTiO₃, CaZrO₃, or the like.

When the first and second base electrode layers 32a and 32b include fired layers, the thickness in the length direction z from the first end surface 12e or the second end surface 12f is preferably, for example, about 3 μm or more and about 20 μm or less. In addition, when the third and fourth base electrode layers 32c and 32d include fired layers, the thickness in the width direction y from the first lateral surface 12c or the second lateral surface 12d is preferably, for example, about 3 μm or more and about 20 μm or less.

When the electrically conductive resin layer is provided as the base electrode layer 32, the electrically conductive resin layer may be provided on the fired layer so as to cover the fired layer, or may be provided directly on the multilayer body 12 without providing the fired layer. The electrically conductive resin layer includes a metal such as electrically conductive particles and a thermosetting resin. The electrically conductive resin layer may completely cover the base electrode layer or may partially cover the base electrode layer.

Since the electrically conductive resin layer includes a thermosetting resin, the electrically conductive resin layer is more flexible than an electrically conductive layer made of, for example, a plating film or a fired product of an electrically conductive paste. For this reason, even when a physical shock or a shock due to a thermal cycle is applied to the three-terminal multilayer ceramic capacitor 10, the electrically conductive resin layer defines and functions as a buffer layer, and it is possible to reduce or prevent cracks in the three-terminal multilayer ceramic capacitor 10.

As the metal included in the electrically conductive resin layer, it is possible to use, for example, Ag, Ni, Sn, Bi, or an alloy including Cu as a main component. In addition, for example, it is also possible to use a metal powder obtained by coating the surface of the metal powder with Ag. When an Ag-coated metal powder is used, it is preferable to use, for example, Cu, Ni, Sn, Bi, or an alloy powder thereof as the metal powder. The reason why the electrically conductive metal powder of Ag is used as the electrically conductive metal is that Ag is suitable for an electrode material because it has the lowest specific resistance among metals, and Ag is a noble metal and has high weather resistance without being oxidized. This is because it is possible to make the metal of the base material inexpensive while maintaining the above-described characteristics of Ag.

Further, for example, as the metal included in the electrically conductive resin layer, it is also possible to use a metal obtained by subjecting Cu or Ni to an antioxidant treatment. In addition, as the metal included in the electrically conductive resin layer, it is also possible to use, for example, a metal powder obtained by coating the surface of the metal powder with Sn, Ni, or Cu. When a metal powder coated with Sn, Ni, or Cu is used, for example, it is preferable to use Ag, Cu, Ni, Sn, Bi, or an alloy powder thereof as the metal powder.

The metal included in the electrically conductive resin layer mainly provides the electrical conductivity of the electrically conductive resin layer. Specifically, when the electrically conductive fillers are in contact with each other, a conduction path is provided inside the electrically conductive resin layer.

As the metal included in the electrically conductive resin layer, for example, it is possible to use a metal having a spherical shape, a metal having a flat shape, or the like, and it is preferable to use a mixture of a spherical metal powder and a flat metal powder.

As the resin of the electrically conductive resin layer, for example, it is possible to use various known thermosetting resins such as an epoxy resin, a phenoxy resin, a phenol resin, a urethane resin, a silicone resin, or a polyimide resin. Among them, an epoxy resin excellent in heat resistance, moisture resistance, adhesion, and the like is one of the preferable resins.

In addition, the electrically conductive resin layer preferably includes a curing agent together with a thermosetting resin. When an epoxy resin is used as the base resin, it is possible to use, for example, various known compounds such as phenol-based, amine-based, acid anhydride-based, imidazole-based, active ester-based, or amide-imide-based compounds as the curing agent of the epoxy resin.

The electrically conductive resin layer may include a plurality of layers.

The plated layer 34 includes a first plated layer 34a, a second plated layer 34b, a third plated layer 34c, and a fourth plated layer 34d. The first plated layer 34a, the second plated layer 34b, the third plated layer 34c, and the fourth plated layer 34d, which are the plated layers 34 that can be provided on the base electrode layer 32, will be described with reference to FIGS. 4 and 5. The first plated layer 34a, the second plated layer 34b, the third plated layer 34c, and the fourth plated layer 34d include, for example, at least one of Cu, Ni, Sn, Ag, Pd, an Ag—Pd alloy, Au, or the like.

The first plated layer 34a is provided so as to cover the first base electrode layer 32a. The second plated layer 34b is provided so as to cover the second base electrode layer 32b. The third plated layer 34c is provided so as to cover the third base electrode layer 32c. The fourth plated layer 34d is provided so as to cover the fourth base electrode layer 32d.

As shown in FIGS. 8A, 8B and 9, the third and fourth plated layers 34c and 34d are respectively provided along the outer surfaces of the third and fourth base electrode layers 32c and 32d. In addition, the third and fourth plated layers 34c and 34d are respectively provided along the first and second separation portions 45a and 45b between the first and second lateral surfaces 12c and 12d and the first and second separation portions 45a and 45b. The characteristic shapes of the third and fourth plated layers 34c and 34d will be described later in detail.

The first plated layer 34a, the second plated layer 34b, the third plated layer 34c, and the fourth plated layer 34d may include a plurality of layers. In this case, it is preferable that the plated layer 34 has a two-layer configuration including a lower plated layer provided on the base electrode layer 32 by Ni plating and an upper plated layer provided on the lower plated layer by Sn plating.

That is, the first plated layer 34a includes a first lower plated layer and a first upper plated layer located on the surface of the first lower plated layer. In addition, the second plated layer 34b includes a second lower plated layer and a second upper plated layer located on the surface of the second lower plated layer. Similarly, the third plated layer 34c includes a third lower plated layer and a third upper plated layer located on the surface of the third lower plated layer. In addition, the fourth plated layer 34d includes a fourth lower plated layer and a fourth upper plated layer located on the surface of the fourth lower plated layer.

The lower plated layer formed by Ni plating is used to prevent the base electrode layer 32 from being eroded by solder when the three-terminal multilayer ceramic capacitor 10 is mounted, and the upper plated layer formed by Sn plating is used to improve wettability of solder when the three-terminal multilayer ceramic capacitor 10 is mounted and to facilitate mounting. The thickness per one plated layer is preferably, for example, about 2.0 μm or more and about 15.0 μm or less.

Next, the shapes of the third and fourth base electrode layers 32c and 32d and the shapes of the third and fourth plated layers 34c and 34d will be further described. The third base electrode layers 32c have the same or substantially the same shape as the fourth base electrode layers 32d, and the third plated layers 34c have the same or substantially the same shape as the fourth plated layers 34d. Therefore, the third base electrode layer 32c and the third plated layer 34c will be described, and the description of the fourth base electrode layer 32d and the fourth plated layer 34d will be omitted or simplified. FIGS. 8A, 8B, and 9 show cross-sectional shapes of the multilayer body 12, the third base electrode layer 32c, and the third plated layer 34c in a cross-sectional view along the first and second main surfaces 12a and 12b. FIGS. 8A, 8B and 9 show an LW cross section (a cross section including the length direction z and the width direction y) at about ½T, for example, when the dimension of the three-terminal multilayer ceramic capacitor 10 in the height direction x is defined as T.

As shown in FIGS. 8A, 8B, and 9, the third base electrode layer 32c is provided on the first lateral surface 12c of the multilayer body 12 in the LW cross section. The third base electrode layer 32c includes a bonding portion 40 including a middle portion 40a, and the separation portions 45. The middle portion 40a is a portion of the third base electrode layer 32c located at a point M that is the middle in the length direction z of the third base electrode layer 32c.

The bonding portion 40 is a portion from a point Q1 adjacent to the first end surface 12e to a point Q2 adjacent to the second end surface 12f, and is bonded to the first lateral surface 12c. At least a portion of the bonding portion 40 is in contact with and bonded to the third extension electrode portion 28b₁. The third extension electrode portion 28b₁ is positioned so as to be accommodated in the bonding portion 40, and extension end portions 29, which are each an end portion of the third extension electrode portion 28b₁, are accommodated between the point Q1 and the point Q2. Specifically, a first extension end portion 29a adjacent to the first end surface 12e is located closer to the second end surface 12f than the point Q1 is, and is not located adjacent to the first end surface 12e beyond the point Q1. Similarly, the second extension end portion 29b adjacent to the second end surface 12f is located closer to the first end surface 12e than the point Q2 is, and is not located adjacent to the second end surface 12f beyond the point Q2.

In the example of FIG. 9, the bonding portion 40 includes an extension electrode bonding portion 41 and ceramic layer bonding portions 42 located on both sides of the extension electrode bonding portion 41. The extension electrode bonding portion 41 refers to a portion bonded to the third extension electrode portion 28b₁. Each of the ceramic layer bonding portions 42 refers to a portion bonded to the ceramic layers 14. The ceramic layer bonding portions 42 include a first ceramic layer bonding portion 42a located closer to the first end surface 12e than the extension electrode bonding portion 41 is, and a second ceramic layer bonding portion 42b located closer to the second end surface 12f than the extension electrode bonding portion 41 is. The separation portions 45 are respectively located in the first ceramic layer bonding portion 42a adjacent to the first end surface 12e and in the second ceramic layer bonding portion 42b adjacent to the second end surface 12f.

At each of the contact interfaces 47 between the third and fourth extension electrode portions 28b₁ and 28b₂ and the bonding portions 40 of the third and fourth base electrode layers 32c and 32d, Ni in the third extension electrode portion 28b₁ and Cu in the third base electrode layer 32c are mutually diffused to form an alloy layer (not shown). This alloy layer is formed to be denser than the third extension electrode portion 28b₁ and the third base electrode layer 32c themselves, and improves the bonding strength between the third extension electrode portion 28b₁ and the third base electrode layer 32c.

The separation portions 45 refer to portions between the end surface-side tip portions 46, which is the tip end of the end portion of the third base electrode layer 32c, and the bonding portion 40, and include the first separation portion 45a and the second separation portion 45b.

The first separation portion 45a refers to a portion located closer to the first end surface 12e than the bonding portion 40 is. Specifically, the first separation portion 45a is located in the vicinity of a portion of the bonding portion 40 adjacent to the first end surface 12e, and is a portion from the point R1 of the first end surface-side tip portion 46a of the end surface-side tip portion 46 adjacent to the first end surface 12e, to the point Q1. Unlike the bonding portion 40 bonded to the first lateral surface 12c, the first separation portion 45a is separated from the first lateral surface 12c. For example, in the examples of FIGS. 8A, 8B, and 9, the separation distance of the lower surface of the first separation portion 45a from the first lateral surface 12c increases from the point Q1, which is the boundary between the first separation portion 45a and the bonding portion 40, toward the first end surface-side tip portion 46a at the point R1. In addition, the upper surface of the first separation portion 45a approaches the first lateral surface 12c from the point Q1 toward the point R1. Therefore, the first separation portion 45a has a shape tapered toward the first end surface-side tip portion 46a.

The second separation portion 45b is a portion located closer to the second end surface 12f than the bonding portion 40 is. Specifically, the second separation portion 45b is located in the vicinity of a portion of the bonding portion 40 adjacent to the second end surface 12f, and is a portion from the point R2 of the second end surface-side tip portion 46b of the end surface-side tip portion 46 adjacent to the second end surface 12f, to the point Q2. Unlike the bonding portion 40 bonded to the first lateral surface 12c, the second separation portion 45b is separated from the first lateral surface 12c. For example, in the examples of FIGS. 8A, 8B, and 9, the separation distance of the lower surface of the second separation portion 45b from the first lateral surface 12c increases from the point Q2, which is the boundary between the second separation portion 45b and the bonding portion 40, toward the second end surface-side tip portion 46b at the point R2. In addition, the upper surface of the second separation portion 45b approaches the first lateral surface 12c from the point Q2 toward the point R2. Therefore, the second separation portion 45b has a shape tapered toward the second end surface-side tip portion 46b.

Next, as shown in FIGS. 8A, 8B, and 9, the third plated layer 34c covers the third base electrode layer 32c in the LW cross section. The third plated layer 34c includes a surface layer portion 50 and edge portions 51. The edge portions 51 include a first edge portion 51a adjacent to the first end surface 12e and a second edge portion 51b adjacent to the second end surface 12f.

The first edge portion 51a extends along the first separation portion 45a between the first separation portion 45a and the first lateral surface 12c. Specifically, according to FIGS. 8A, 8B, and 9, the first edge portion 51a extends along the lower surface of the first separation portion 45a from the first end surface-side tip portion 46a at the point R1 to the location where the first separation portion 45a comes into contact with the first lateral surface 12c, and includes an outer surface from the first edge portion tip portion 52a to the first edge portion contact portion 53a. The first edge portion tip portion 52a is located at a point shifted from the first end surface side tip portion 46a toward the first end surface 12e by the thickness of the first edge portion 51a, and refers to a tip portion of the first edge portion 51a adjacent to the first end surface 12e. The first edge portion contact portion 53a is a portion where the first edge portion 51a first contacts the first lateral surface 12c. The first edge portion tip portion 52a is located closer to the first end surface 12e than the first edge portion contact portion 53a is. A gap is provided between the third plated layer 34c and the first lateral surface 12c from the first edge portion tip portion 52a to the first edge portion contact portion 53a.

The second edge portion 51b is provided along the second separation portion 45b between the second separation portion 45b and the first lateral surface 12c. Specifically, according to FIGS. 8A, 8B, and 9, the second edge portion 51b extends along the lower surface of the second separation portion 45b from the second end surface side tip portion 46b at the point R2 to the location where the second separation portion 45b comes into contact with the first lateral surface 12c, and includes an outer surface from the second edge portion tip portion 52b to the second edge portion contact portion 53b. The second edge portion tip portion 52b is located at a point shifted from the second end surface side tip portion 46b toward the second end surface 12f by the thickness of the second edge portion 51b, and refers to a tip portion of the second edge portion 51b adjacent to the second end surface 12f. The second edge portion contact portion 53b is a portion where the second edge portion 51b first contacts the first lateral surface 12c. The second edge portion tip portion 52b is located closer to the second end surface 12f than the second edge portion contact portion 53b is. A gap is provided between the third plated layer 34c and the first lateral surface 12c from the second edge portion tip portion 52b to the second edge portion contact portion 53b.

The surface layer portion 50 covers the outer surface of the third base electrode layer 32c continuously from the first edge portion 51a and the second edge portion 51b. Specifically, the surface layer portion 50 covers the outer surface of the third base electrode layer 32c from a portion including the first end surface-side tip portion 46a and the first edge portion tip portion 52a to a portion including the second end surface-side tip portion 46b and the second edge portion tip portion 52b.

As shown in FIG. 9, for example, it is preferable that about 0.01≤h/e≤about 0.20, where h is defined as the distance h1 in the length direction z of the first separation portion 45a (the distance from the point R1 to the point Q1) and the distance h2 in the length direction z of the second separation portion 45b (the distance from the point R2 to the point Q2), and e is defined as the width in the length direction z of the third base electrode layer 32c (the distance from the point R1 to the point R2).

In addition, for example, it is preferable that about 0.20≤d/c≤about 0.80, where c is defined as the thickness of the middle portion 40a in the width direction y with respect to the first lateral surface 12c, and d is defined as the separation distance d1 in the width direction y of the first end surface-side tip portion 46a with respect to the first lateral surface 12c and the separation distance d2 in the width direction y of the second end surface-side tip portion 46b with respect to the first lateral surface 12c.

In addition, for example, when a distance P1 from the first extension end portion 29a to the first separation portion 45a (the distance from the point Q1 to the point S1) and a distance P2 from the second extension end portion 29b to the second separation portion 45b (the distance from the point Q2 to the point S2) are respectively defined as P, it is preferable that 0<P.

In addition, for example, it is preferable that 0<P/e≤about 0.20.

In addition, for example, a point which is about 50 μm from the middle portion 40a toward the first end surface 12e is defined as T1, a point which is about 100 μm from the middle portion 40a toward the first end surface 12e is defined as T2, a point which is about 50 μm from the middle portion 40a toward the second end surface 12f is defined as T3, and a point which is about 100 μm from the middle portion 40a toward the second end surface 12f is defined as T4. In addition, for example, the thicknesses in the width direction y from the first lateral surface 12c at the points T1 to T4 are defined as t1, t2, t3, and t4, respectively. When t1 to t4 are collectively referred to as t, it is preferable that about 0.8≤t/c≤about 1.3.

In addition, for example, it is preferable that about 270 μm≤e≤about 600 μm.

In addition, for example, it is preferable that about 15 μm≤c≤about 30 μm.

Next, the fourth base electrode layer 32d and the fourth plated layer 34d have the same or substantially the same configuration as the third base electrode layer 32c and the fourth plated layer 34d, but will be briefly described below. The fourth base electrode layer 32d includes a bonding portion 40 that includes a middle portion 40a and is bonded to the second lateral surface 12d, a first separation portion 45a that is separated from the second lateral surface 12d and located closer to the first end surface 12e than the bonding portion 40 is, and a second separation portion 45b that is separated from the second lateral surface 12d and located closer to the second end surface 12f than the bonding portion 40 is. The fourth plated layer 34d includes a first edge portion 51a extending along the first separation portion 45a between the first separation portion 45a and the second lateral surface 12d, a second edge portion 51b extending along the second separation portion 45b between the second separation portion 45b and the second lateral surface 12d, and a surface layer portion 50 continuously covering the outer surface of the fourth base electrode layer 32d from the first edge portion 51a and the second edge portion 51b.

In addition, the distance h (h1 and h2) in the length direction z of each of the first and second separation portions 45a and 45b in the fourth base electrode layer 32d, the width e in the length direction z of the fourth base electrode layer 32d, the thickness c of the middle portion 40a in the width direction y with respect to the second lateral surface 12d, the separation distance d (d1 and d2) in the width direction y of each of the first and second end surface-side tip portions 46a and 46b with respect to the second lateral surface 12d, and the distance P (P1 and P2) from each of the first and second extension end portions 29a and 29b to the first and second separation portions 45a and 45b are the same or substantially the same as described above for the third base electrode layer 32c.

In addition, as shown in FIGS. 4, 6, and 7, unlike the third and fourth base electrode layers 32c and 32d, the first and second base electrode layers 32a and 32b are in contact with the multilayer body 12 in a portion facing the multilayer body 12. In other words, the first base electrode layer 32a is bonded to the multilayer body 12 on a surface opposed to the first end surface 12e, a surface opposed to the first main surface 12a, a surface opposed to the second main surface 12b, a surface opposed to the first lateral surface 12c, and a surface opposed to the second lateral surface 12d, and does not include any separation portion. In addition, the second base electrode layer 32b is bonded to the multilayer body 12 on a surface opposed to the second end surface 12f, a surface opposed to the first main surface 12a, a surface opposed to the second main surface 12b, a surface opposed to the first lateral surface 12c, and a surface opposed to the second lateral surface 12d, and does not include any separation portion. The first and second plated layers 34a and 34b respectively cover the first and second base electrode layers 32a and 32b.

The dimension in the length direction z of the three-terminal multilayer ceramic capacitor 10 including the multilayer body 12 and the first to fourth external electrodes 30a to 30d is defined as an L dimension, the dimension in the height direction x is defined as a T dimension, and the dimension in the width direction y is defined as a W dimension. The dimensions of the three-terminal multilayer ceramic capacitor 10 are not particularly limited, but, for example, the L dimension in the length direction z is about 1.05 mm or more and about 1.35 mm or less, the T dimension in the height direction x is about 0.45 mm or more and about 0.90 mm or less, and the W dimension in the width direction y is about 0.60 mm or more and about 0.95 mm or less. In addition, it is possible to measure the dimensions of the three-terminal multilayer ceramic capacitor 10 by a microscope.

Next, an example of a method of manufacturing a three-terminal multilayer ceramic capacitor will be described.

First, a dielectric sheet for manufacturing a ceramic layer and an electrically conductive paste for manufacturing an internal electrode layer are prepared. The dielectric sheet and the electrically conductive paste for manufacturing the internal electrode layer includes a binder and a solvent. The binder and the solvent may be known.

Then, an electrically conductive paste for manufacturing the internal electrode layer is printed on the dielectric sheet in a predetermined pattern by, for example, gravure printing or screen printing. With such a configuration, the dielectric sheet on which the pattern of the first internal electrode layer is formed and the dielectric sheet on which the pattern of the second internal electrode layer is formed are prepared.

Subsequently, a predetermined number of dielectric sheets for manufacturing the outer layer on which the pattern of the internal electrode layer is not printed are laminated to form a portion defining and functioning as the second main surface-side outer layer portion on the second main surface. Then, the dielectric sheet on which the pattern of the first internal electrode layer is printed and the dielectric sheet on which the pattern of the second internal electrode layer is printed are sequentially laminated on the portion defining and functioning as the second main surface-side outer layer portion so as to have the configuration of an example embodiment of the present invention, such that the portion defining and functioning as the inner layer portion is formed. A predetermined number of dielectric sheets for manufacturing the outer layer on which the pattern of the internal electrode layer is not printed are laminated on the portion defining and functioning as the inner layer portion, such that the portion defining and functioning as the first main surface-side outer layer portion on the first main surface is formed. With such a configuration, a multilayer sheet is produced.

Next, a multilayer block is produced by pressing the laminated sheet in the lamination direction by, for example, isostatic pressing or the like.

Then, the multilayer chip is cut out by cutting the multilayer block into a predetermined size. At this time, corner portions and ridge portions of the multilayer chip may be rounded by, for example, barrel polishing or the like.

Subsequently, a multilayer body is produced by firing the cut-out multilayer chip. The firing temperature is preferably, for example, about 900° C. or more and about 1400° C. or less depending on the materials of the ceramic layers and the internal electrode layers.

Next, the third base electrode layer 32c of the third external electrode 30c is formed on the first lateral surface 12c of the multilayer body 12 obtained by firing, and the fourth base electrode layer 32d of the fourth external electrode 30d is formed on the second lateral surface 12d of the multilayer body 12.

The third and fourth base electrode layers 32c and 32d can be formed by the following manufacturing method using, for example, an external electrode paste. As a first application step, a first external electrode paste is applied to the first and second lateral surfaces 12c and 12d of the multilayer body 12 at positions where the third and fourth base electrode layers 32c and 32d are to be formed, and then dried at, for example, about 150° C. or less. Further, as a second application step, a second external electrode paste is applied on the first external electrode paste and dried at, for example, about 150° C. or less. Thereafter, the multilayer body 12 applied with the first and second external electrode pastes is fired. It is considered that the first and second separation portions 45a and 45b are formed in the third and fourth base electrode layers 32c and 32d due to a difference in thickness between the first and second external electrode pastes, characteristics of the external electrode paste being more likely to contract in the lateral direction than the multilayer body 12 during firing, and the like.

The external electrode paste is required to be a paste capable of forming the third and fourth base electrode layers 32c and 32d having the above-described shapes. In addition, as the external electrode paste, it is preferable to use a paste that can reduce or prevent bulging of the middle portion compared to the end portion when the base electrode layer 32 is formed using the external electrode paste.

For example, the external electrode paste includes a resin, a metal filler, and a solvent. As a result, the middle portion 40a of the third and fourth base electrode layers 32c and 32d can be prevented from swelling, and the three-terminal multilayer ceramic capacitor 10 can be prevented from increasing in size and can be reduced in thickness and size.

The type of the resin is not particularly limited as long as the desired advantageous effects are not inhibited. As the resin, various resins conventionally blended in an external electrode paste can be used without particular limitation. Examples of preferred resins include cellulose resins, acrylic resins, or butyral resins. From the viewpoint of easily obtaining an external electrode paste having a viscosity suitable for forming an external electrode, it is particularly preferable that the resin includes a cellulose-based resin, for example. It is also preferable that the resin includes, for example, a copolymer resin including a block derived from a cellulose-based resin. The copolymer resin may be, for example, a block copolymer or a graft copolymer.

The cellulose-based resin is, for example, at least one of ethyl cellulose, methyl cellulose, hydroxypropyl cellulose, trityl cellulose, acetyl cellulose, carboxymethyl cellulose, or nitrocellulose.

The acrylic resin is, for example, a homopolymer or copolymer of one or more monomers including isobutyl methacrylate, methyl methacrylate, hydroxyethyl methacrylate, hydroxypropyl methacrylate, n-butyl methacrylate, or 2-ethylhexyl methacrylate.

The metal filler is made of a metal of the external electrode. The type of metal of the metal filler is appropriately selected according to the type of metal of the external electrode. For example, copper (Cu), silver (Ag), nickel (Ni), or an alloy including these metals is preferable as the metal in view of excellent electrical conductivity and easy availability of a metal filler having a desired particle size. The alloy including these metals preferably includes one or more of copper (Cu), silver (Ag), or nickel (Ni). It is also preferable that the alloy including these metals include tin (Sn), for example.

The solvent dissolves the resin, disperses the metal filler, and is added as a component that provides fluidity to the external electrode paste.

The solvent includes one or more first solvents and one or more second solvents. The ratio of the mass of the first solvent to the mass of the solvent and the ratio of the mass of the second solvent to the mass of the solvent are each, for example, about 40% by mass or more. The lowest boiling point T^{Hl} among the boiling points of the one or more second solvents under atmospheric pressure is, for example, higher by about 10° C. or more than the highest boiling point T^{Lh} among the boiling points of the one or more first solvents under atmospheric pressure. Among the boiling points of one or more second solvents under atmospheric pressure, the highest boiling point T^{Hh} is, for example, equal to or lower than T^{Hl}+about 10° C. Among the boiling points of one or more first solvents under atmospheric pressure, the lowest boiling point T^{Ll} is, for example, equal to or higher than T^{Lh}−about 10° C. The solvent may include a sub-solvent in addition to the first solvent and the second solvent. The boiling point of the sub-solvent under atmospheric pressure is, for example, less than (T^{Ll}−10) ° C., greater than (T^{Lh}+10) ° C. and less than (T^{Hl}−10) ° C., or greater than (T^{Hh}+10° C.)

Specific examples of suitable solvents include texanol, propylene glycol monophenyl ether, butyl carbitol, terpene solvents, diethylene glycol, carbitol acetate, butyl carbitol acetate, benzyl alcohol, methyl propylene diglycol, diphenyl ether, ethylene glycol, or the like.

In addition, for example, the external electrode paste includes a resin including an ethylcellulose-based resin and an acrylic resin, at least a portion of which is copolymerized, a Cu filler, and a solvent. The interfacial tension generated between the resin and the solvent is preferably, for example, about 15 mN/m or more. The resin and the solvent are as described above.

Next, an example of a manufacturing method in a case in which the base electrode layer 32 is a fired layer or an electrically conductive resin layer will be described.

When a fired layer is formed as the third base electrode layer 32c and the fourth base electrode layer 32d, an electrically conductive paste (paste for manufacturing an external electrode) including a glass component and a metal component is applied, and then firing is performed to form a base electrode layer. The electrically conductive paste can be applied by, for example, the first application step and the second application step described above. Thereafter, firing is performed to form a base electrode layer. The temperature of the firing treatment at this time is preferably, for example, about 700° C. or more and about 900° C. or less. In addition, in the Experimental Examples described later, the base electrode layer 32 includes a fired layer.

Here, it is possible to use various methods as a method of forming the fired layer. For example, it is possible to use a method of applying an electrically conductive paste by extruding the electrically conductive paste from a slit. In this method, by increasing the extrusion amount of the electrically conductive paste, it is possible to form the base electrode layer 32 not only on the first lateral surface 12c and the second lateral surface 12d but also on a portion of the first main surface 12a and a portion of the second main surface 12b. In addition, it is also possible to form by a roller transfer method, for example. In the case of the roller transfer method, when the base electrode layer 32 is formed not only on the first lateral surface 12c and the second lateral surface 12d but also on a portion of the first main surface 12a and a portion of the second main surface 12b, it is possible to form the base electrode layer 32 on a portion of the first main surface 12a and a portion of the second main surface 12b by increasing the pressing pressure during roller transfer.

In addition, when the third base electrode layer 32c and the fourth base electrode layer 32d are formed of an electrically conductive resin layer, it is possible to form the electrically conductive resin layer by the following method, for example. In addition, the electrically conductive resin layer may be formed on the surface of the fired layer, or the electrically conductive resin layer may be formed directly on the multilayer body 12 as a single body without forming the fired layer.

As an example of a method of forming the electrically conductive resin layer, an electrically conductive resin paste (paste for manufacturing an external electrode) including a thermosetting resin and a metal component is applied onto the fired layer or the multilayer body 12. The electrically conductive resin paste can be applied by, for example, the first application step and the second application step described above. Heat treatment is performed at a temperature, for example, ranging from about 250° C. to about 550° C. to thermally cure the resin to form the electrically conductive resin layer. At this time, the atmosphere during the heat treatment is preferably, for example, an N₂ atmosphere. In addition, in order to prevent scattering of the resin and oxidation of various metal components, it is preferable that the oxygen concentration is, for example, about 100 ppm or less.

In addition, as a method of applying the electrically conductive resin paste, for example, it is possible to use a method of applying the electrically conductive resin paste by extruding the electrically conductive resin paste through a slit or a roller transfer method in the same or substantially the same manner as the method of forming the base electrode layer 32 with the fired layer.

Next, the first base electrode layer 32a of the first external electrode 30a and the second base electrode layer 32b of the second external electrode 30b are formed on the first end surface 12e and the second end surface 12f, respectively, in the multilayer body obtained by firing. In the case of forming a fired layer as the first base electrode layer 32a and the second base electrode layer 32b, an electrically conductive paste including a glass component and a metal component is applied and then firing is performed to form a base electrode layer. The temperature of the firing treatment at this time is preferably, for example, about 700° C. or more and about 900° C. or less. As a method of applying the electrically conductive paste to both end surfaces of the multilayer body, for example, a method such as a dipping method or a screen printing method is used. In the Experimental Examples described later, the first base electrode layer 32a and the second base electrode layer 32b are formed by dipping so as to extend not only to the first end surface 12e and the second end surface 12f but also to a portion of the first main surface 12a, a portion of the second main surface 12b, a portion of the first lateral surface 12c, and a portion of the second lateral surface 12d.

In addition, in the firing process, the third base electrode layer 32c, the fourth base electrode layer 32d, the first base electrode layer 32a, and the second base electrode layer 32b may be simultaneously fired, or may be fired on both lateral surfaces 12c and 12d and on both end surfaces 12e and 12f separately.

In addition, for example, when the base electrode layer includes a fired layer, the fired layer may include a dielectric component. In this case, a dielectric component may be included instead of the glass component, or both of them may be included.

The dielectric component is preferably, for example, a dielectric material of the same type as the multilayer body. In addition, when a dielectric component is included in the fired layer, it is preferable that the electrically conductive paste is applied to the multilayer chip before firing, and the multilayer chip before firing and the electrically conductive paste applied to the multilayer chip before firing are simultaneously fired (fired) to form a multilayer body in which the fired layer is formed. The temperature of the firing treatment at this time (firing temperature) is preferably, for example, about 900° C. or more and about 1400° C. or less.

Next, the plated layer 34 is formed. The plated layer 34 may be formed on the surface of the base electrode layer 32 or may be formed directly on the multilayer body 12. In addition, in the Experimental Examples described later, the plated layer 34 is formed on the surface of the base electrode layer 32. More specifically, for example, a Ni plated layer is formed as a lower plated layer on the base electrode layer 32, and a Sn plated layer is formed as an upper plated layer. It is possible to sequentially form the Ni plated layer and the Sn plated layer by barrel plating, for example. When plating is performed, either electrolytic plating or electroless plating may be used. However, electroless plating requires pretreatment with a catalyst or the like in order to improve the plating deposition rate, and has a disadvantage that the process becomes complicated. Therefore, in general, it is preferable to use electrolytic plating.

As described above, the three-terminal multilayer ceramic capacitor 10 according to the present example embodiment is manufactured.

Hereinafter, the advantageous effects of the three-terminal multilayer ceramic capacitor 10 will be described.

According to the above configuration, it is possible to reduce or prevent the occurrence of cracks due to the stress relaxation by the third and fourth base electrode layers 32c and 32d, and it is possible to further ensure the surface areas of the third and fourth plated layers 34c and 34d by the first and second edge portions 51a and 51b, such that it is possible to improve the bonding property and the mountability with the board. This will be specifically described below.

The third and fourth base electrode layers 32c and 32d are bonded to the first and second lateral surfaces 12c and 12d at the bonding portion 40, and are separated from the first and second lateral surfaces 12c and 12d at the first and second separation portions 45a and 45b respectively located closer to the first and second end surfaces 12e and 12f than the bonding portion 40 is. The first and second separation portions 45a and 45b relax the stress when the three-terminal multilayer ceramic capacitor 10 is bent due to stress such as thermal stress and mechanical stress. For example, when stress acts on the three-terminal multilayer ceramic capacitor 10, the first and second separation portions 45a and 45b are deformed by warping in a direction away from or approaching the first and second lateral surfaces 12c and 12d, thus relaxing the stress. In addition, for example, when stress acts on the three-terminal multilayer ceramic capacitor 10, the stress can be further relaxed by peeling off a portion of the bonding portion 40 from the first and second lateral surfaces 12c and 12d with the first and second separation portions 45a and 45b as a starting point in a state where the stress is relaxed by the first and second separation portions 45a and 45b. A portion of the bonding portion 40 refers to, for example, at least a portion of each of the third and fourth base electrode layers 32c and 32d, which is not bonded to the third extension electrode portions 28b₁ or the fourth extension electrode portion 28b₂, but is bonded to the ceramic layers 14 of the multilayer body 12 (the first and second ceramic layer bonding portions 42a and 42b). As described above, since the third and fourth base electrode layers 32c and 32d each include the first and second separation portions 45a and 45b, it is possible to relax the stress acting on the three-terminal multilayer ceramic capacitor 10 as compared with the case where the third and fourth base electrode layers 32c and 32d are bonded to the first and second lateral surfaces 12c and 12d on all of the surfaces opposed to the first and second lateral surfaces 12c and 12d, such that it is possible to reduce or prevent cracks.

In addition, the third and fourth plated layers 34c and 34d each include not only the surface layer portion 50 covering the outer surfaces of the third and fourth base electrode layers 32c and 32d, but also first and second edge portions 51a and 51b provided along the lower surfaces of the first and second separation portions 45a and 45b. Therefore, the surface areas of the third and fourth plated layers 34c and 34d can be increased by at least a portion of the first and second edge portions 51a and 51b. For example, because the first and second separation portions 45a and 45b are separated from the first and second lateral surfaces 12c and 12d, at least portions of the first and second edge portions 51a and 51b provided along the first and second separation portions 45a and 45b may also be provided to be separated from the first and second lateral surfaces 12c and 12d. In this case, it is possible to increase the surface areas of the third and fourth plated layers 34c and 34d as a whole by not only the area of the surface layer portion 50, but also the area of the first and second edge portions 51a and 51b that is not bonded to the multilayer body 12 and is exposed. Therefore, it is possible to increase the bonding area between the third and fourth plated layers 34c and 34d and the solder, and it is possible to improve the bonding property and mountability of the three-terminal multilayer ceramic capacitor 10 to the board.

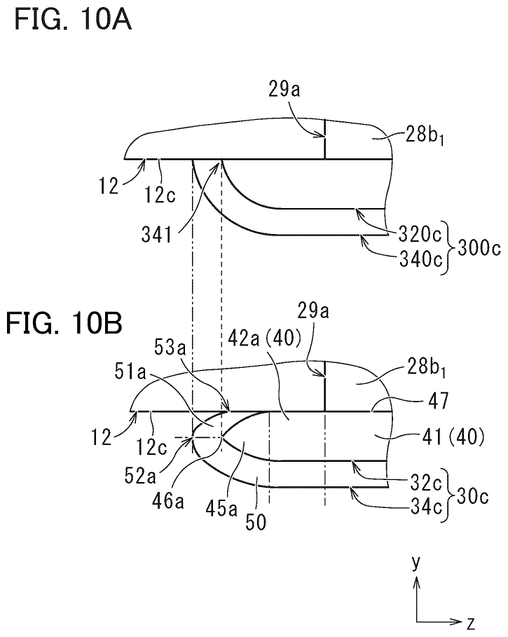

The fact that the bonding area between the third and fourth plated layers 34c and 34d and the solder can be increased will be further described with reference to FIG. 10. FIG. 10A is a schematic cross-sectional view showing a configuration of a third base electrode layer and a third plated layer in an existing three-terminal multilayer ceramic capacitor, and FIG. 10B a schematic cross-sectional view showing a configuration of a third base electrode layer and a third plated layer in a three-terminal multilayer ceramic capacitor according to an example embodiment of the present invention. As shown in FIG. 10A, in the existing three-terminal multilayer ceramic capacitor, the third external electrode 300c includes a third base electrode layer 320c and a third plated layer 340c. The third base electrode layer 320c is in contact with the first lateral surface 12c at a portion opposed to the first lateral surface 12c of the multilayer body 12, and is in contact with the first lateral surface 12c at the tip 341. The third plated layer 340c covers the upper surface of the third base electrode layer 320c.

On the other hand, as shown in FIG. 10B, in the three-terminal multilayer ceramic capacitor 10 according to the present example embodiment of the present invention, the third base electrode layer 32c includes the first separation portion 45a. It is assumed that the tip 341 of the third base electrode layer 320c and the first end surface-side tip portion 46a of the first separation portion 45a are located at the same or substantially the same position. The third plated layer 34c covers the third base electrode layer 32c, and at least a portion of the first edge portion 51a is separated from the first lateral surface 12c. That is, a gap is provided between the first edge portion 51a and the first lateral surface 12c from the first edge portion tip portion 52a to the first edge portion contact portion 53a, and the first edge portion 51a is exposed. It is possible to increase the bonding area between the third plated layer 34c and the solder by at least the area of the exposed portion.

Unlike the third and fourth external electrodes 30c and 30d, the first and second external electrodes 30a and 30b do not include the separation portion 45 separated from the multilayer body 12. For example, the first and second extension electrode portions 28a₁ and 28a₂ are respectively extended so as to be exposed only to a portion of the first end surface 12e and a portion of the second end surface 12f, and are coupled to the first and second external electrodes 30a and 30b at the extended portions. The ratio of the bonding area of the first and second external electrodes 30a and 30b and the first and second extension electrode portions 28a₁ and 28a₂ to the area of the first and second external electrodes 30a and 30b covering the first and second end surfaces 12e and 12f may be relatively smaller than the ratio of the bonding area of the third and fourth external electrodes 30c and 30d and the third and fourth extension electrode portions 28b₁ and 28b₂ to the area of the third and fourth external electrodes 30c and 30d covering the first and second lateral surfaces 12c and 12d. Here, since an alloy layer is formed by the metal component of the external electrode 30 and the metal component of the extension electrode portions 28a₁ to 28b₂ at the interface between the external electrode 30 and the extension electrode portions 28a₁ to 28b₂, the bonding strength is high. Therefore, the bonding strength between the first and second external electrodes 30a and 30b and the first and second extension electrode portions 28a₁ and 28a₂ having a relatively small ratio of the bonding area is smaller than the bonding strength between the third and fourth external electrodes 30c and 30d and the third and fourth extension electrode portions 28b₁ and 28b₂. Therefore, the first and second external electrodes 30a and 30b are more likely to peel off from the multilayer body 12 than the third and fourth external electrodes 30c and 30d. Thus, as described above, by bringing the first and second external electrodes 30a and 30b into contact with the multilayer body 12 without separating them from each other and bonding them, it is possible to reduce or prevent the first and second external electrodes 30a and 30b from being easily peeled off from the first and second extension electrode portions 28a₁ and 28a₂ when stress acts on the three-terminal multilayer ceramic capacitor 10. With such a configuration, it is possible to reduce or prevent an increase in the dimension of the three-terminal multilayer ceramic capacitor 10 due to the first and second external electrodes 30a and 30b being peeled off from the multilayer body 12 and warping up from the surface of the multilayer body 12.

The third and fourth extension electrode portions 28b₁ and 28b₂ are bonded to the bonding portions 40 of the third and fourth base electrode layers 32c and 32d, and are not bonded to the third and fourth plated layers 34c and 34d. At the contact interface 47 of the bonding portion 40, an alloy layer is formed by the metal components of the third and fourth base electrode layers 32c and 32d and the metal components of the third and fourth extension electrode portions 28b₁ and 28b₂, and the third and fourth base electrode layers 32c and 32d are firmly bonded to the third and fourth extension electrode portions 28b₁ and 28b₂. On the other hand, at least a portion of the first and second edge portions 51a and 51b of the third and fourth plated layers 34c and 34d provided along the first and second separation portions 45a and 45b is bonded to the ceramic layers 14 of the multilayer body 12, and is not in contact with the third and fourth extension electrode portions 28b₁ and 28b₂. The bonding strength between the third and fourth plated layers 34c and 34d and the ceramic layers 14 of the multilayer body 12 is smaller than the bonding strength between the third and fourth base electrode layers 32c and 32d and the third and fourth extension electrode portions 28b₁ and 28b₂. Therefore, when stress acts on the three-terminal multilayer ceramic capacitor 10, deformation such as warping of the first and second separation portions 45a and 45b and the third and fourth plated layers 34c and 34d in a direction away from or approaching the first and second lateral surfaces 12c and 12d, peeling of a portion of the bonding portion 40, and the like may occur. Therefore, even when the third and fourth plated layers 34c and 34d covering the third and fourth base electrode layers 32c and 32d are formed, the stress is easily relaxed. With such a configuration, it is possible to further reduce or prevent cracks in the three-terminal multilayer ceramic capacitor.

By setting h/e to the range of, for example about 0.01≤h/e≤about 0.20, it is possible to ensure the bonding portion 40 for bonding the third and fourth base electrode layers 32c and 32d to the multilayer body 12, while ensuring the first and second separation portions 45a and 45b for suppressing cracks. Specifically, when h/e is about 0.01 or more, it is possible to ensure the first and second separation portions 45a and 45b, such that it is possible to reduce or prevent cracks. In addition, when h/e is about 0.20 or less, it is possible to ensure the bonding portion 40 other than the first and second separation portions 45a and 45b, such that it is possible to ensure the bonding of the third and fourth base electrode layers 32c and 32d to the multilayer body 12.

B setting d/c in the range of, for example, about 0.20≤d/c≤about 0.80, it is possible to reduce or prevent an increase in the dimension of the three-terminal multilayer ceramic capacitor 10, while ensuring the first and second separation portions 45a and 45b for suppressing cracks. Specifically, when d/c is about 0.20 or more, it is possible to separate the first and second end surface-side tip portions 46a and 46b from the first and second lateral surfaces 12c and 12d, such that it is possible to ensure the first and second separation portions 45a and 45b. It is thus possible to reduce or prevent cracks. In addition, since d/c is about 0.80 or less, the separation distance d between the first and second end surface-side tip portions 46a and 46b and the first and second lateral surfaces 12c and 12d is reduced, such that it is possible to reduce or prevent an increase in the dimension of the three-terminal multilayer ceramic capacitor 10, thus achieving a reduction in thickness and size. In addition, even when the first and second separation portions 45a and 45b warp in a direction away from or approaching the first and second lateral surfaces 12c and 12d due to stress acting on the three-terminal multilayer ceramic capacitor 10, it is possible to reduce or prevent an increase in the dimension of the three-terminal multilayer ceramic capacitor 10.

Since 0<P, the third and fourth extension electrode portions 28b₁ and 28b₂ are located at the bonding portion 40 between the first separation portion 45a and the second separation portion 45b. That is, the third and fourth extension electrode portions 28b₁ and 28b₂ are covered with the third and fourth base electrode layers 32c and 32d, and do not extend into the positions of the first and second separation portions 45b. Therefore, it is possible to reduce or prevent moisture infiltration into the multilayer body 12 through the third and fourth extension electrode portions 28b₁ and 28b₂, and to improve moisture resistance reliability. In addition, in the bonding portion 40, since the alloy layer is formed by the third and fourth base electrode layers 32c and 32d and the third and fourth extension electrode portions 28b₁ and 28b₂, it is possible to firmly bond the third and fourth base electrode layers 32c and 32d to the third and fourth extension electrode portions 28b₁ and 28b₂.

When P/e is in the range of, for example, about 0<P/e≤about 0.20, it is possible to reduce or prevent an increase in the dimensions of the three-terminal multilayer ceramic capacitor 10, while improving the moisture resistance reliability. Specifically, by setting P/e to be larger than about 0, the third and fourth extension electrode portions 28b₁ and 28b₂ are located at the bonding portion 40 between the first separation portion 45a and the second separation portion 45b as in the case where P is larger than 0. Therefore, it is possible to improve moisture resistance reliability. In addition, since P/e is about 0.20 or less, it is possible to reduce or prevent the ratio of the distance P from the first and second extension end portions 29a and 29b to the first and second separation portions 45a and 45b to the width e of the third and fourth base electrode layers 32c and 32d from becoming too large. That is, by reducing the ratio of the distance P to the width e, it is possible to design the width e of the third and fourth base electrode layers 32c and 32d to be small, while ensuring the bonding portion 40. Therefore, it is possible to reduce or prevent an increase in size of the three-terminal multilayer ceramic capacitor 10, thus achieving a reduction in the thickness and size thereof.

The symbol t/c represents the flatness of the bonding portion 40. Since t/c is in the range of, for example, about 0.8≤t/c≤about 1.3, the bonding portion 40 can be flat or substantially flat, and it is possible to an increase in the size of the three-terminal multilayer ceramic capacitor 10, thus achieving a reduction in the thickness and size thereof.

By setting the width e within the range of, for example, about 270 μm≤e≤about 600 μm, it is possible to reduce or prevent an increase in the size of the three-terminal multilayer ceramic capacitor 10, thus achieving a reduction in thickness and size thereof.

By setting the thickness c within the range of, for example, about 15 μm≤c≤about 30 μm, it is possible to reduce or prevent an increase in the size of the three-terminal multilayer ceramic capacitor 10, thus achieving a reduction in the thickness and size thereof.

Next, as a sample of an experiment, three-terminal multilayer ceramic capacitors were manufactured by the manufacturing method described above. As experimental examples, Experimental Example 1 and Experimental Example 2 were performed. In Experimental Example 1, the three-terminal multilayer ceramic capacitors of Examples 1-1 to 1-5 in which the dimensions of the respective portions of the base electrode layer were different from each other were prepared, and subjected to a moisture resistance reliability test, an adhesion test, and a deflection test (deflection amount: about 2 mm). In Experimental Example 2, three-terminal multilayer ceramic capacitors were prepared in which P was varied in the base electrode layer and the dimensions and the like of each portion other than P were constant, and a moisture resistance reliability test, an adhesion test, a deflection test (deflection amount: about 2 mm), and a deflection test (deflection amount: about 3 mm) were performed.

Experimental Example 1 will be described below.

Three-terminal multilayer ceramic capacitors according to Examples 1-1 to 1-5 were produced in accordance with the above-described method for producing a multilayer ceramic capacitor.

Here, for the dimensions of each portion of the third and fourth base electrode layers, the distance from the first extension end portion to the first separation portion is defined as P1, the distance from the second extension end portion to the second separation portion is defined as P2, the distance in the length direction z of the first separation portion is defined as h1, the distance in the length direction z of the second separation portion is defined as h2, the separation distance in the width direction y of the first end surface-side tip portion is defined as d1, the separation distance in the width direction y of the second end surface-side tip portion is defined as d2, the width in the length direction z of the third and fourth base electrode layers is defined as e, and the thickness in the width direction y of the middle portion is defined as c. The thicknesses at the points T1 to T4 are defined as t1 to t4, respectively.

Table 1 shows P1 (μm), P1/e, P2 (μm), P2/e, h1 (μm), h1/e, h2 (μm), h2/e, d1 (μm), d1/c, d2 (μm), d2/c, e (μm), and c (μm) for Examples 1-1 to 1-5.

TABLE 1

| Sample | P, P/e | | | | h, h/e | | | | d, d/c | | | | | |
|---|---|---|---|---|---|---|---|---|---|---|---|---|---|---|
| Number | P1(um) | P1/e | P2(um) | P2/e | h1(um) | h1/e | h2(um) | h2/e | d1(um) | d1/c | d2(um) | d2/c | e(um) | c(um) |
| Example 1-1 | 6.2 | 0.02 | 41.9 | 0.14 | 14.8 | 0.05 | 19.8 | 0.07 | 7.3 | 0.36 | 6.1 | 0.30 | 295.0 | 20.1 |
| Example 1-2 | 8.9 | 0.03 | 2.8 | 0.01 | 32.3 | 0.12 | 40.7 | 0.15 | 11.2 | 0.57 | 13.9 | 0.70 | 279.7 | 19.8 |
| Example 1-3 | 4.5 | 0.02 | 3.1 | 0.01 | 33.7 | 0.12 | 41.0 | 0.15 | 11.3 | 0.59 | 12.5 | 0.65 | 280.0 | 19.2 |
| Example 1-4 | 52.2 | 0.18 | 15.1 | 0.05 | 22.0 | 0.08 | 21.5 | 0.07 | 6.2 | 0.32 | 6.1 | 0.31 | 288.9 | 19.5 |
| Example 1-5 | 51.6 | 0.17 | 22.6 | 0.08 | 17.0 | 0.06 | 10.9 | 0.04 | 5.2 | 0.28 | 5.9 | 0.32 | 299.8 | 18.7 |

Table 2 shows t1 to t4 (μm), c (μm), and t1/c to t4/c for Examples 1-1 to 1-5.

TABLE 2

| | | | | | Middle | | | | |
|---|---|---|---|---|---|---|---|---|---|
| | Point T1 | | Point T2 | | portion | Point T3 | | Point T4 | |
| Example No. | t1(um) | t1/c | t2(um) | t2/c | c(um) | t3(um) | t3/c | t4(um) | t4/c |
| Example 1-1 | 18.6 | 0.93 | 19.9 | 0.99 | 20.1 | 20.7 | 1.03 | 20.1 | 1.00 |
| Example 1-2 | 22.6 | 1.14 | 20.4 | 1.03 | 19.8 | 19.8 | 1.00 | 24.0 | 1.21 |
| Example 1-3 | 22.6 | 1.18 | 19.5 | 1.02 | 19.2 | 20.4 | 1.06 | 13.7 | 1.23 |
| Example 1-4 | 18.7 | 0.96 | 19.5 | 1.00 | 19.5 | 20.4 | 1.05 | 18.7 | 0.96 |
| Example 1-5 | 18.1 | 0.97 | 19.5 | 1.04 | 18.7 | 18.4 | 0.98 | 18.1 | 0.97 |

The configuration of the three-terminal multilayer ceramic capacitor other than the dimensions of the third and fourth base electrode layers shown in Tables 1 and 2 is as follows, and is common to Examples 1-1 to 1-5.
Configuration of Three-Terminal Multilayer Ceramic Capacitor: Three Terminals (see FIG. 1)
Dimensions L×W×T (including design value) of Three-Terminal Multilayer Ceramic Capacitor: about 1.23 mm×about 0.93 mm×about 0.48 mm
Material of Ceramic Layers: BaTiO₃
Capacitance: about 22 μF
Rated Voltage: about 4 V
First Internal Electrode Layers
   Material: Ni
   Shape: see FIG. 6
   Number of Layers: 220 layers
   Thickness of the First Internal Electrode Layers in the Height Direction x: about 0.42 μm
Second Internal Electrode Layers
   Material: Ni
   Shape: see FIG. 7
   Number of Layers: 220 layers
   Thickness of the Second Internal Electrode Layers in the Height Direction x: about 0.42 μm
Configuration of External Electrode
   First External Electrode and Second External Electrode
   Base Electrode Layer: Fired layer including electrically conductive metal (Cu) and glass component
Thickness of middle portion of end surface: about 16 μm
   Plated Layer: Two-layer configuration of Ni plated layer and Sn plated layer
   Thickness of Ni plated layer: about 5 μm
   Thickness of Sn plated layer: about 5 μm
   Third External Electrode and Fourth External Electrode
   Base Electrode Layer: Fired layer including electrically conductive metal (Cu) and glass component
   Plated Layer: Two-layer configuration of Ni plated layer and Sn plated layer
   Thickness of Ni plated layer: about 4 μm
   Thickness of Sn plated layer: about 5 μm

With respect to Examples 1-1 to 1-5, a moisture resistance reliability test, an adhesion test, and a deflection test (deflection amount: 2 mm) were performed.

Moisture resistance reliability tests were performed on the samples of Examples 1-1 to 1-5 based on the PCBT test method. More specifically, first, each sample was mounted on a mounting board using solder. Subsequently, the insulation resistance value IR of each sample was measured (the insulation resistance value after one hour from the start of the moisture resistance reliability test time). Next, the mounting board was placed in a high-temperature and high-humidity bath, and in an environment of about 125° C. and a relative humidity of about 95% RH, a DC current of about 4 V was applied between the first external electrode and the second external electrode of each sample and between the third external electrode and the fourth external electrode of each sample, and maintained for about 72 hours (humidity resistance reliability test time). After the moisture resistance reliability test time, the insulation resistance value IR of each sample was measured (the insulation resistance value after the moisture resistance reliability test time). For each sample, when the log IR after the moisture resistance reliability test time was lower than the log IR before the moisture resistance reliability test time by a power of about 0.5 or more, it was determined that the sample was deteriorated by IR. A sample having no IR degradation was determined to be good (indicated by circle symbol “O”), and a sample having IR degradation was determined to be poor (indicated by cross symbol “x”).

The samples of Examples 1-1 to 1-5 were subjected to an adhesion test. More specifically, first, each sample was mounted on a mounting board using solder. Subsequently, the capacitance, the insulation resistance value IR, and the DC resistance value Rdc of each sample before the test were measured. The middle portion of each sample was pressed with a pressing jig at a pressure of about 5 N and an acceleration of about 0.1 mm/s with the soldering surface of each sample facing down, and held for about 10 seconds. Thereafter, the capacitance, the insulation resistance value IR, and the DC resistance value Rdc of each sample after the test were measured. When the capacitance and the insulation resistance value IR satisfied the initial standard and the rate of change of the DC resistance value Rdc before and after the test was about ±20% or less, the result was judged to be good (indicated by circle symbol “◯”), and in other cases, the result was judged to be poor (indicated by cross symbol “x”).

The samples of Examples 1-1 to 1-5 were subjected to a deflection test (deflection amount: about 2 mm). More specifically, first, each sample was mounted on a mounting board (a single-layer board having a thickness of about 0.8 mm) using solder. Each sample was deflected by about 2 mm in the L direction (length direction z) at an acceleration of about 1.0 mm/s, and held for about 5 seconds. When no cracks occurred, the result was evaluated as good (indicated by circle symbol “o”), and when cracks occurred, the result was evaluated as poor (indicated by cross symbol “x”).

Table 3 shows the results of the moisture resistance reliability test, the adhesion test, and the deflection test (deflection amount: about 2 mm) of each of the samples of Examples 1-1 to 1-5.

TABLE 3

| | Example | | | | |
|---|---|---|---|---|---|
| Test | Example 1-1 | Example 1-2 | Example 1-3 | Example 1-4 | Example 1-5 |
| Moisture Resistance | ◯ | ◯ | ◯ | ◯ | ◯ |
| Reliability Test | | | | | |
| Adhesion Force | ◯ | ◯ | ◯ | ◯ | ◯ |
| Test | | | | | |
| Deflection Test | ◯ | ◯ | ◯ | ◯ | ◯ |
| (Deflection Amount 2 mm) | | | | | |

In Examples 1-1 to 1-5 shown in Tables 1 to 3, the results of the moisture resistance reliability test, the adhesion test, and the deflection test (deflection amount: about 2 mm) were good (indicated by circle symbol “o”). From Table 1, it was discovered that, for example, it was preferable that about 0.01≤h/e≤about 0.20 with reference to the minimum value and the maximum value of h1/e and h2/e. It is more preferable that, for example, about 0.04≤h/e≤about 0.15. Referring to Table 1, it was discovered that, for example, about 0.20≤d/c≤about 0.80 was preferable with reference to the minimum value and the maximum value of d1/c and d2/c. It is more preferable that, for example, about 0.28≤h/e≤about 0.70. From Table 1, it was discovered that it was preferable that, for example, about 0<P/e≤about 0.20 with reference to the minimum value and the maximum value of P1/e and P2/e. It is more preferable that, for example, about 0.01<P/e≤about 0.18. From Table 2, it was discovered that, for example, about 0.8≤t/c≤about 1.3 was preferable by referring to the minimum value and the maximum value of t1/c, t2/c, t2/c, and t4/c. It is more preferable that, for example, about 0.93≤t/c≤about 1.23. With reference to the minimum value and the maximum value of e from Table 1, it was discovered that, for example, about 270 μm≤e≤about 600 μm was preferable. It is more preferable that, for example, about 280 μm≤e≤about 300 μm. Referring to the minimum value and the maximum value of c from Tables 1 and 2, it was discovered that, for example, about 15 μm≤c≤about 30 μm was preferable. It is more preferable that, for example, about 19 μm≤c≤about 20 μm.

Experimental Example 2 will be described below.

In accordance with the above-described method for manufacturing a multilayer ceramic capacitor, samples having separation portions of d=about 5 μm or more and different P were prepared as Examples 2-1 to 2-5. As Comparative Example 1, a sample having d=about 0 μm and no separation portions was prepared. In Examples 2-1 to 2-5, three-terminal multilayer ceramic capacitors in which h1, h2, e, c, d1, d2, and t1 to t4 were average values of Examples 1-1 to 1-5 were produced. Specifically, in Experimental Example 2, h1=about 24.0 μm, h2=about 26.8 μm, e=about 288.7 μm, c=about 19.5 μm, d1=about 8.2 μm, d2=about 8.9 μm, t1=about 20.1 μm, t2=about 19.8 μm, t3=about 19.9 μm, and t4=about 20.9 μm. In addition, in Examples 2-1 to 2-5, P/e≤0, about 0<P/e<about 0.02, about 0.02≤P/e<about 0.05, about 0.05≤P/e<about 0.1, and about 0.1≤P/e were set, respectively. Other configurations of the three-terminal multilayer ceramic capacitor were the same or substantially the same as those in Experimental Example 1.

On the other hand, in Comparative Example 1, d1 and d2 were set to about 0, and other configurations of the three-terminal multilayer ceramic capacitor were the same or substantially the same as those of Examples 1-1 to 1-5.

Examples 2-1 to 2-5 and Comparative Example 1 were subjected to a moisture resistance reliability test, an adhesion test, a deflection test (deflection amount: about 2 mm), and a deflection test (deflection amount: about 3 mm). The test methods in the moisture resistance reliability test, the adhesion test, and the deflection test (deflection amount: 2 mm) in Examples 2-1 to 2-5 and Comparative Example 1 were the same or substantially the same as those in Experimental Example 1 described above. The deflection test (deflection amount: about 3 mm) was the same test method as the deflection test (deflection amount: about 2 mm) except that it was deflected by about 3 mm. In each of the moisture resistance reliability test, the adhesion test, the deflection test (deflection amount: about 2 mm), and the deflection test (deflection amount: about 3 mm), 10 samples were prepared for each of Examples 2-1 to 2-5 and Comparative Example 1, and the number of defects was counted.

Table 4 shows the results of the moisture resistance reliability test, the adhesion test, the deflection test (deflection amount: 2 mm), and the deflection test (deflection amount: 3 mm) of Examples 2-1 to 2-5 and Comparative Example 1.

TABLE 4

| | | | | | | No separation |
|---|---|---|---|---|---|---|
| | | | | | | portion |
| | Range of P/e (with separation portion) | | | | | d = 0 |
| | d = 5 μm or more | | | | | Comparative |
| | Example 2-1 | Example 2-2 | Example 2-3 | Example 2-4 | Example 2-5 | Example 1 |
| Test | P/e ≤0 | 0≤ P/e <0.02 | 0.02≤ P/e <0.05 | 0.05≤ P/e <0.1 | 0.1≤ P/e | — |
| Moisture Resistance | 7/10 | 0/10 | 0/10 | 0/10 | 0/10 | 0/10 |
| Reliability Test | | | | | | |
| Adhesion Force | 3/10 | 0/10 | 0/10 | 0/10 | 0/10 | 0/10 |
| Test | | | | | | |
| Deflection Test | 0/10 | 0/10 | 0/10 | 0/10 | 0/10 | 3/10 |
| (Deflection Amount 2 mm) | | | | | | |
| Deflection Test | 0/10 | 0/10 | 1/10 | 0/10 | 1/10 | 9/10 |
| (Deflection Amount 3 mm) | | | | | | |

When P/e 0, a defect occurred in 7 out of 10 in the moisture resistance reliability test, and a defect occurred in 3 out of 10 in the adhesion test. In Examples 2-2 to 2-5 of 0<P/e and Comparative Example 1, no defects occurred in the moisture resistance reliability test. Therefore, it was discovered that 0<P was preferable.

In the case of Comparative Example 1 including no separation portions, a defect occurred in 3 out of 10 in the deflection test (deflection amount of about 2 mm), and a defect occurred in 9 out of 10 in the deflection test (deflection amount of about 3 mm). That is, in Comparative Example 1 in which the separation portion was not provided, cracks were generated due to the stress caused by deflection. On the other hand, in the case of Examples 2-1 to 2-5 having the separation portions, no defect occurred in the deflection test (deflection amount of about 2 mm), and some defects occurred in the deflection test (deflection amount of about 3 mm). Therefore, in Examples 2-1 to 2-5 including the separation portions, the stress due to the deflection was relaxed, and the occurrence of cracks was substantially reduced or prevented.

In addition, as described above, although example embodiments of the present invention are disclosed in the above description, the present invention is not limited thereto. That is, example embodiments of the present invention can be modified in various ways with respect to the configuration, the shape, the material, the quantity, the position, the arrangement, and the like of the example embodiments described above without departing from the technical idea and the scope of the present invention, and these modifications are included in the present invention.

(1) In an example embodiment, the lower surfaces of the separation portions 45 of the third and fourth base electrode layers 32c and 32d are gradually separated from the first and second lateral surfaces 12c and 12d from the bonding portion 40 to the end surface-side tip portion 46 (from the point Q1 (Q2) to the point R1 (R2)), and the upper surfaces of the separation portions 45 gradually approach to the first and second lateral surfaces 12c and 12d from the bonding portion 40 to the end surface-side tip portion 46. That is, the separation portion 45 has a tapered shape. However, the lower surface of the separation portion 45 may be separated from the first and second lateral surfaces 12c and 12d by a constant or substantially constant separation distance from the bonding portion 40 to the end surface-side tip portion 46. In addition, the upper surface of the separation portion 45 may have a substantially constant separation distance from the first and second lateral surfaces 12c and 12d from the bonding portion 40 to the end surface-side tip portion 46.

(2) In an example embodiment, each of the third and fourth base electrode layers 32c and 32d includes the separation portion 45 separated from the first and second lateral surfaces 12c and 12d. However, each of the third and fourth base electrode layers 32c and 32d may include a bonding portion and a separation portion in a portion opposed to the first and second main surfaces 12a and 12b.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-terminal multilayer ceramic capacitor comprising:
a multilayer body including a plurality of ceramic layers and a plurality of internal electrode layers that are laminated, a first main surface and a second main surface opposed to each other in a height direction, a first end surface and a second end surface opposed to each other in a length direction orthogonal or substantially orthogonal to the height direction, and a first lateral surface and a second lateral surface opposed to each other in a width direction orthogonal or substantially orthogonal to the height direction and the length direction; and
a plurality of external electrodes; wherein
the plurality of internal electrode layers include:
a plurality of first internal electrode layers each extending toward the first end surface and the second end surface; and
a plurality of second internal electrode layers each extending toward the first lateral surface and the second lateral surface;
the plurality of external electrodes include:
a first external electrode including a first base electrode layer and a first plated layer on the first base electrode layer, the first external electrode being provided on the first end surface and connected to the plurality of first internal electrode layers;
a second external electrode including a second base electrode layer and a second plated layer on the second base electrode layer, the second external electrode being provided on the second end surface and connected to the plurality of first internal electrode layers;
a third external electrode including a third base electrode layer and a third plated layer on the third base electrode layer, the third external electrode being provided on the first lateral surface and connected to the plurality of second internal electrode layers; and
a fourth external electrode including a fourth base electrode layer and a fourth plated layer on the fourth base electrode layer, the fourth external electrode being provided on the second lateral surface and connected to the plurality of second internal electrode layers;
the plurality of first internal electrode layers each include a first counter electrode portion opposed to a corresponding one of the plurality of second internal electrode layers, a first extension electrode portion extending from the first counter electrode portion toward the first end surface, and a second extension electrode portion extending from the first counter electrode portion toward the second end surface;
the plurality of second internal electrode layers each include a second counter electrode portion opposed to a corresponding one of the plurality of first counter electrode portions, a third extension electrode portion extending from the second counter electrode portion toward the first lateral surface, and a fourth extension electrode portion extending from the second counter electrode portion toward the second lateral surface;
in a cross-sectional view along the first main surface and the second main surface, each of the third base electrode layer and the fourth base electrode layer includes a bonding portion including a middle portion located at a middle in the length direction and bonded to a corresponding one of the first lateral surface and the second lateral surface, a first separation portion located closer to the first end surface than the bonding portion is and separated from a corresponding one of the first lateral surface and the second lateral surface, and a second separation portion located closer to the second end surface than the bonding portion is and separated from a corresponding one of the first lateral surface and the second lateral surface;
in the cross-sectional view along the first main surface and the second main surface, each of the third plated layer and the fourth plated layer includes a first edge portion extending along the first separation portion between the first separation portion and a corresponding one of the first lateral surface and the second lateral surface, a second edge portion extending along the second separation portion between the second separation portion and a corresponding one of the first lateral surface and the second lateral surface, and a surface layer portion covering an outer surface of a corresponding one of the third base electrode layer and the fourth base electrode layer continuously from the first edge portion and the second edge portion.

2. The three-terminal multilayer ceramic capacitor according to claim 1, wherein the first external electrode and the second external electrode are in contact with the multilayer body in a portion facing the multilayer body.

3. The three-terminal multilayer ceramic capacitor according to claim 1, wherein each of the third extension electrode portion and the fourth extension electrode portion is bonded to the bonding portion of a corresponding one of the third base electrode layer and the fourth base electrode layer.

4. The three-terminal multilayer ceramic capacitor according to claim 1, wherein, in the cross-sectional view along the first main surface and the second main surface, when h is defined as a distance in the length direction of the first separation portion and a distance in the length direction of the second separation portion, and when e is defined as a width in the length direction of each of the third base electrode layer and the fourth base electrode layer, a relationship of about 0.01≤h/e≤about 0.20 is satisfied.

5. The three-terminal multilayer ceramic capacitor according to claim 1, wherein, in the cross-sectional view along the first main surface and the second main surface, when c is defined as a thickness in the width direction of the middle portion with respect to a corresponding one of the first lateral surface and the second lateral surface, and when d is defined as a separation distance in the width direction of each of a first end surface-side tip portion which is a tip portion closest to the first end surface in the first separation portion and a second end surface-side tip portion which is a tip portion closest to the second end surface in the second separation portion with respect to each of the first lateral surface and the second lateral surface, a relationship of about 0.20≤d/c≤about 0.80 is satisfied.

6. The three-terminal multilayer ceramic capacitor according to claim 1, wherein
each of the third extension electrode portion and the fourth extension electrode portion includes a first extension end portion adjacent to the first end surface and a second extension end portion adjacent to the second end surface; and
when a distance from the first extension end portion to the first separation portion and a distance from the second extension end portion to the second separation portion are respectively defined as P, a relationship of 0<P is satisfied.

7. The three-terminal multilayer ceramic capacitor according to claim 6, wherein, when e is defined as a width in the length direction of each of the third base electrode layer and the fourth base electrode layer, a relationship of about 0<P/e≤about 0.20 is satisfied.

8. The three-terminal multilayer ceramic capacitor according to claim 1, wherein, in the cross-sectional view along the first main surface and the second main surface, when c is defined as a thickness in the width direction of the middle portion with respect to each of the first lateral surface and the second lateral surface, and when t is defined as a thickness in the width direction of the bonding portion, a relationship of about 0.8≤t/c≤about 1.3 is satisfied.

9. The three-terminal multilayer ceramic capacitor according to claim 1, wherein, when e is defined as a width in the length direction of each of the third base electrode layer and the fourth base electrode layer, a relationship of about 270 μm≤e≤about 600 μm is satisfied.

10. The three-terminal multilayer ceramic capacitor according to claim 1, wherein, in the cross-sectional view along the first main surface and the second main surface, when c is defined as a thickness in the width direction of the middle portion with respect to each of the first lateral surface and the second lateral surface, a relationship of about 15 μm≤c≤about 30 μm is satisfied.

11. The three-terminal multilayer ceramic capacitor according to claim 1, further comprising:
an external electrode paste included in the plurality of external electrodes; wherein
the external electrode paste includes:
a resin;
a metal filler; and
a solvent; wherein
the solvent includes one or more first solvents and one or more second solvents;
a ratio of a mass of the first solvent to a mass of the solvent and a ratio of a mass of the second solvent to a mass of the solvent are each about 40% by mass or more;
a lowest boiling point T^{Hl} among boiling points of the one or more second solvents under atmospheric pressure is higher by about 10° C. or more than a highest boiling point T^{Lh} among boiling points of the one or more first solvents under atmospheric pressure;
a highest boiling point T^{Hh} among the boiling points of the one or more second solvents under atmospheric pressure is T^{Hl}+about 10° C. or less;
a lowest boiling point T^{Ll} among the boiling points of the one or more first solvents under atmospheric pressure is T^{Lh}−about 10° C. or more;
the solvent includes a sub-solvent in addition to the first solvent and the second solvent;
a boiling point of the sub-solvent under atmospheric pressure is less than (T^{Ll}−about 10) ° C., greater than (T^{Lh}+about 10°) C and less than (T^{Hl}−about 10°) C, or greater than (T^{Hh}+about 10°) C; or
the metal filler includes a Cu filler; and
the resin includes an ethylcellulose-based resin and an acrylic resin, at least a portion of which is copolymerized, and an interfacial tension generated between the resin and the solvent is about 15 mN/m or more.

12. The three-terminal multilayer ceramic capacitor according to claim 1, wherein, when e is defined as a width in the length direction of each of the third base electrode layer and the fourth base electrode layer, a relationship of about 280 μm≤e≤about 300 μm is satisfied.

13. The three-terminal multilayer ceramic capacitor according to claim 1, wherein, in the cross-sectional view along the first main surface and the second main surface, when h is defined as a distance in the length direction of the first separation portion and a distance in the length direction of the second separation portion, and when e is defined as a width in the length direction of each of the third base electrode layer and the fourth base electrode layer, a relationship of about 0.04≤h/e≤about 0.15 is satisfied.

14. The three-terminal multilayer ceramic capacitor according to claim 1, wherein, in the cross-sectional view along the first main surface and the second main surface, when c is defined as a thickness in the width direction of the middle portion with respect to a corresponding one of the first lateral surface and the second lateral surface, and when d is defined as a separation distance in the width direction of each of a first end surface-side tip portion which is a tip portion closest to the first end surface in the first separation portion and a second end surface-side tip portion which is a tip portion closest to the second end surface in the second separation portion with respect to each of the first lateral surface and the second lateral surface, a relationship of about 0.28≤d/c≤about 0.70 is satisfied.

15. The three-terminal multilayer ceramic capacitor according to claim 1, wherein, when e is defined as a width in the length direction of each of the third base electrode layer and the fourth base electrode layer, a relationship of about 0.01<P/e≤about 0.18 is satisfied.

16. The three-terminal multilayer ceramic capacitor according to claim 1, wherein, in the cross-sectional view along the first main surface and the second main surface, when c is defined as a thickness in the width direction of the middle portion with respect to each of the first lateral surface and the second lateral surface, and when t is defined as a thickness in the width direction of the bonding portion, a relationship of about 0.93≤t/c≤about 1.23 is satisfied.

17. The three-terminal multilayer ceramic capacitor according to claim 1, wherein, when c is defined as a thickness in the width direction of the middle portion with respect to each of the first lateral surface and the second lateral surface, about 15 μm≤c≤about 30 μm is satisfied.

18. The three-terminal multilayer ceramic capacitor according to claim 1, wherein, when c is defined as a thickness in the width direction of the middle portion with respect to each of the first lateral surface and the second lateral surface, about 19 μm≤c≤about 20 μm is satisfied.
